(19) United States
(12) Patent Application Publication
(10) Pub. No.: US 2025/0319543 A1
(43) Pub. Date: Oct. 16, 2025

(54) LASER MACHINING HEAD, LASER MACHINING APPARATUS, AND METHOD FOR MANUFACTURING METAL PRODUCT

(71) Applicants: Mitsubishi Electric Corporation, Tokyo (JP); TADA ELECTRIC CO., LTD., Hyogo (JP)

(72) Inventors: Yuzuru TADOKORO, Tokyo (JP); Kazuki KUBA, Tokyo (JP); Yosuke MATSUI, Hyogo (JP); Hiroki NAGAE, Hyogo (JP)

(73) Assignees: Mitsubishi Electric Corporation, Tokyo (JP); TADA ELECTRIC CO., LTD., Hyogo (JP)

(21) Appl. No.: 18/867,826

(22) PCT Filed: Jun. 17, 2022
(86) PCT No.: PCT/JP2022/024350

§ 371 Date: Nov. 21, 2024

(51) Int. Cl. B23K 26/06; B23K 26/046

(52) U.S. Cl. CPC B23K 26/0648; B23K 26/046

(57) ABSTRACT

A laser machining head includes: an aberration optical system disposed at a position within a range in which laser light emitted toward a workpiece spreads in a propagation direction of the laser light, and causing aberration; and a collimating optical system through which the laser light propagates. A center region of the aberration optical system has no refractive power or has refractive power with an absolute value equal to or less than 1/10 of refractive power of the collimating optical system. A peripheral region of the aberration optical system where a distance from the central axis exceeds the boundary value, has a light collecting characteristic in which when a light ray parallel to the central axis is incident on the peripheral region, the light ray at a position farther from the central axis has a shorter distance between the aberration optical system and a focal point of the light ray.

### FIELD

The present disclosure relates to a laser machining head of a laser machining apparatus that locally melts a workpiece by irradiation with laser light to machine the workpiece, a laser machining apparatus, and a method for manufacturing a metal product.

### BACKGROUND

In recent years, near infrared lasers that output laser light in a near infrared region, such as fiber lasers, Yttrium Aluminum Garnet (YAG) lasers, or direct diode lasers (DDL), have been improved in focusing and output, and laser machining apparatuses using a near infrared laser as a light source have been developed.

Patent Literature 1 discloses a laser machining head including an optical system including a first lens that collects laser light and a second lens disposed on the same optical axis as the first lens. In the optical system described in Patent Literature 1, a first region of the second lens located on the optical axis has no lens characteristic, and a second region of the second lens surrounding the first region diverges laser light.

### CITATION LIST

### Patent Literature

Patent Literature 1: Japanese Patent Application Laid-open No. 2014-73526

### SUMMARY OF INVENTION

### Problem to be Solved by the Invention

In the conventional laser machining head described in Patent Literature 1, energy intensity of a peripheral portion, which is a portion away from the optical axis, of the laser light may change due to a change in the divergence angle of the laser light incident on the optical system or the like. When the energy intensity of the peripheral portion changes, machining becomes unstable due to a defect such as instability of a keyhole formed in the workpiece or occurrence of spatter. For this reason, the conventional laser machining head is problematic in that machining can become unstable.

The present disclosure has been made in view of the above, and an object thereof is to obtain a laser machining head capable of realizing stable machining.

### Means to Solve the Problem

In order to solve the above-described problems and achieve the object, a laser machining head according to the present disclosure includes: an aberration optical system disposed at a position within a range in which laser light emitted toward a workpiece spreads in a propagation direction of the laser light, and causing aberration; and a collimating optical system through which the laser light propagates. A center region of the aberration optical system, the center region being a region where a distance from a central axis of the aberration optical system is equal to or less than a boundary value, has no refractive power or has a refractive power with an absolute value equal to or less than 1/10 of a refractive power of the collimating optical system. A peripheral region of the aberration optical system, the peripheral region being a region where a distance from the central axis exceeds the boundary value, has a light collecting characteristic in which when a light ray parallel to the central axis is incident on the peripheral region, the light ray at a position farther from the central axis has a shorter distance between the aberration optical system and a focal point of the light ray.

### Effects of the Invention

The laser machining head according to the present disclosure can achieve the effect of realizing stable machining.

### BRIEF DESCRIPTION OF DRAWINGS

FIG. 1 is a first diagram for explaining the definition of lateral aberration in the first embodiment.

FIG. 2 is a second diagram for explaining the definition of lateral aberration in the first embodiment.

FIG. 3 is a diagram illustrating a configuration of a laser machining apparatus according to a first example of the first embodiment.

FIG. 4 is a first diagram for explaining the relationship between the state of laser machining and aberration in the first embodiment.

FIG. 5 is a second diagram for explaining the relationship between the state of laser machining and aberration in the first embodiment.

FIG. 6 is a third diagram for explaining the relationship between the state of laser machining and aberration in the first embodiment.

FIG. 7 is a diagram illustrating the beam shape of the laser light illustrated in FIG. 4.

FIG. 8 is a diagram illustrating the beam shape of the laser light illustrated in FIG. 5.

FIG. 9 is a diagram illustrating the beam shape of the laser light illustrated in FIG. 6.

FIG. 10 is a diagram illustrating a configuration of a laser machining apparatus according to a second example of the first embodiment.

FIG. 11 is a diagram for explaining a change in lateral aberration caused by moving the aberration lens in the second example of the first embodiment.

FIG. 12 is a diagram illustrating a configuration of a laser machining apparatus according to a third example of the first embodiment.

FIG. 13 is a diagram for explaining a change in lateral aberration caused by moving the aberration lens in the third example of the first embodiment.

FIG. 14 is a diagram for explaining a configuration of the aberration optical system in the first embodiment.

FIG. 15 is a diagram for explaining a change in the relationship between the lateral aberration and the divergence angle in a case where the aspherical shape of the aberration lens is changed in the first embodiment.

FIG. 16 is a diagram for explaining a change in beam profile in a case where the aspherical shape of the aberration lens is changed in the first embodiment.

FIG. 17 is a diagram illustrating an example of the relationship between the aspherical coefficient and the lateral aberration in the first embodiment.

FIG. 18 is a diagram illustrating an example of parameters for the aberration lenses having the characteristics that are the relationships illustrated in FIG. 17.

FIG. 19 is a diagram illustrating an example of the relationship between the aberration ΔYₒ caused by the machining optical system and the aspherical coefficient A₄ in a case where the convex aberration lens is used in the first embodiment.

FIG. 20 is a diagram illustrating an example of the relationship between the aberration ΔYₒ caused by the machining optical system and the movement amount d of the aberration lens in a case where the convex aberration lens is used in the first embodiment.

FIG. 21 is a diagram illustrating an example of the relationship between the aspherical coefficient A₄ and the movement amount d of the aberration lens in a case where the convex aberration lens is used in the first embodiment.

FIG. 22 is a diagram illustrating an example of the relationship between the aberration ΔYₒ caused by the machining optical system and the aspherical coefficient A₄ in a case where the concave aberration lens is used in the first embodiment.

FIG. 23 is a diagram illustrating an example of the relationship between the aberration ΔYₒ caused by the machining optical system and the movement amount d of the aberration lens in a case where the concave aberration lens is used in the first embodiment.

FIG. 24 is a diagram illustrating an example of the relationship between the aspherical coefficient A₄ and the movement amount d of the aberration lens in a case where the concave aberration lens is used in the first embodiment.

FIG. 25 is a diagram illustrating an example of parameters for the aberration lens having the characteristics that are the relationships illustrated in FIGS. 19 to 21 and the aberration lens having the characteristics that are the relationships illustrated in FIGS. 22 to 24.

FIG. 26 is a diagram illustrating a configuration of a laser machining apparatus according to a first example of the second embodiment.

FIG. 27 is a diagram for explaining a configuration of the aberration optical system in the second embodiment.

FIG. 28 is a diagram illustrating a configuration of a laser machining apparatus according to a second example of the second embodiment.

FIG. 29 is a diagram illustrating a configuration of a laser machining apparatus according to a third example of the second embodiment.

FIG. 30 is a diagram illustrating a configuration of a laser machining apparatus according to a first example of the third embodiment.

FIG. 31 is a diagram illustrating a configuration of a laser machining apparatus according to a second example of the third embodiment.

FIG. 32 is a diagram illustrating an exemplary configuration of a control circuit according to the third embodiment.

FIG. 33 is a diagram illustrating an exemplary configuration of a dedicated hardware circuit according to the third embodiment.

### DESCRIPTION OF EMBODIMENTS

Hereinafter, a laser machining head, a laser machining apparatus, and a method for manufacturing a metal product according to embodiments will be described in detail with reference to the drawings.

### First Embodiment

Prior to describing the laser machining apparatus according to the first embodiment, the definition of lateral aberration in the first embodiment will be described. The definition of the lateral aberration described herein is common to the first embodiment and the second and third embodiments described later.

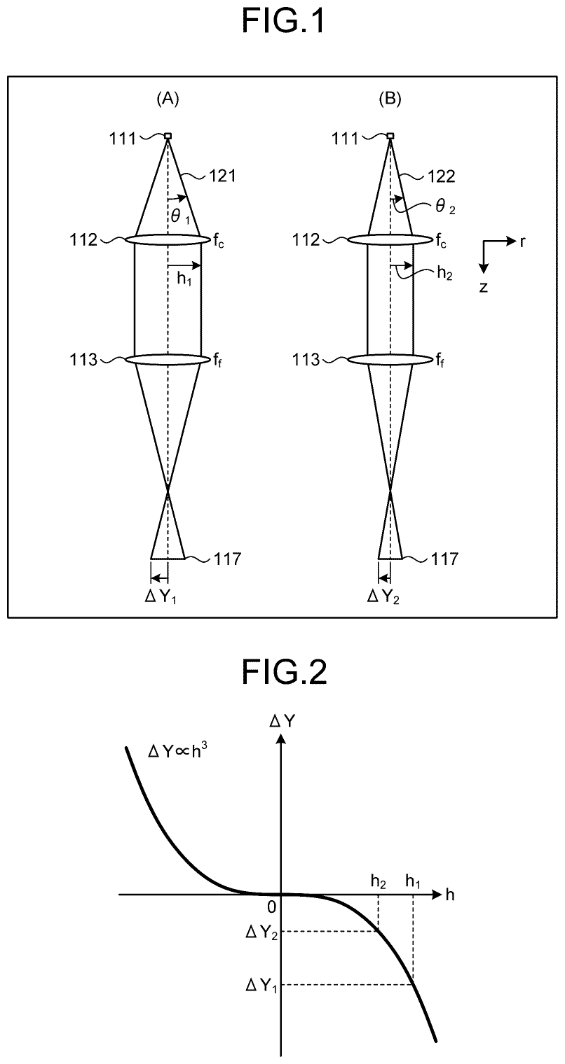

FIG. 1 is a first diagram for explaining the definition of lateral aberration in the first embodiment. FIG. 1 schematically illustrates a state in which a light ray emitted from a light source passes through a collimating optical system and a condensing optical system and is collected. In FIG. 1, the light source is a point light source 111. FIGS. 1(A) and (B) illustrate a difference in behavior of light rays in a case where light rays having different divergence angles are emitted from the point light source 111. FIG. 1(A) illustrates a state in which a light ray having a divergence angle θ₁ is emitted from the point light source 111. FIG. 1(B) illustrates a state in which a light ray having a divergence angle θ₂ is emitted from the point light source 111. Here, θ₁>θ₂>>0 is satisfied. The divergence angle is expressed by a half angle.

In the following description, the collimating optical system is a collimator lens 112 that is a single lens. The condensing optical system is a condenser lens 113 that is a single lens. The collimator lens 112 is a lens that does not cause aberration. The collimator lens 112 may be a lens that causes negligibly small aberration. The condenser lens 113 is a spherical lens that causes spherical aberration. The collimator lens 112 is disposed at a position where the distance from the point light source 111 is f_{c}. The distance f_{c} is the focal length of the collimator lens 112. A distance f_{f} is the focal length of the condenser lens 113. The z direction is the direction of the central axis of each of the collimating optical system and the condensing optical system. The optical axis of the laser light overlaps with the central axis. The r direction is one of the directions perpendicular to the central axis, and is the radial direction of each of the collimator lens 112 and the condenser lens 113.

A light ray 121 is a light ray emitted from the point light source 111 at the divergence angle θ₁. A light ray 122 is a light ray emitted from the point light source 111 at the divergence angle θ₂. The light ray 121 having passed through the collimator lens 112 becomes a light ray having a height h₁ from the optical axis through collimation. The light ray 122 having passed through the collimator lens 112 becomes a light ray having a height h₂ from the optical axis through collimation. h₁=f_{c} tanθᵢ (i=1, 2) holds. Given that θᵢ is sufficiently small and the approximation of tanθᵢ=θᵢ holds, hᵢ≈f_{c}θᵢ holds. In the following description, the height of a light ray from the optical axis is referred to as a light ray height.

The collimated light rays 121 and 122 are collected by the condenser lens 113. In the case of the divergence angle θ₁, the collimated light ray 121 is collected by the condenser lens 113, resulting in a lateral aberration ΔY₁ at a paraxial focus 117. In the case of the divergence angle θ₂, the collimated light ray 122 is collected by the condenser lens 113, resulting in a lateral aberration ΔY₂ at the paraxial focus 117.

FIG. 2 is a second diagram for explaining the definition of lateral aberration in the first embodiment. FIG. 2 is a graph representing the relationship between the lateral aberration ΔY and the light ray height h. A lateral aberration ΔYᵢ caused by the spherical aberration is proportional to the cube of the light ray height hᵢ (ΔYᵢ∝hᵢ³). When the approximation of tanθᵢ≈θᵢ holds, the lateral aberration ΔYᵢ is proportional to the cube of the divergence angle θᵢ (ΔYᵢ∝θᵢ³) according to hᵢ≈f_{c}θᵢ.

In FIG. 1, the r direction that is the radial direction is defined such that the light ray height hᵢ is positive when the divergence angle θᵢ is positive. ΔYᵢ illustrated in FIG. 1 occurs in the negative direction of r, and thus is a negative lateral aberration. This result shows that given θᵢ>θ₂, ΔY₁<ΔY₂ and |ΔY₁|>|ΔY₂| hold. Hereinafter, the lateral aberration generated in the negative direction of r is defined as a negative lateral aberration, and the lateral aberration generated in the positive direction of r is defined as a positive lateral aberration.

Note that, in FIG. 1, in order to simply describe the relationship between the lateral aberration and the divergence angle, the light ray 121 emitted from the point light source 111 at the divergence angle θ₁ and the light ray 122 emitted from the point light source 111 at the divergence angle θ₂ are used for description. In each of the following embodiments, the lateral aberration of laser light is defined for the light ray emitted at the angle corresponding to the divergence angle among the laser light emitted from the emission unit such as the emission end of the optical fiber, and the lateral aberration defined for the light ray is referred to as the lateral aberration as in the case of the point light source 111.

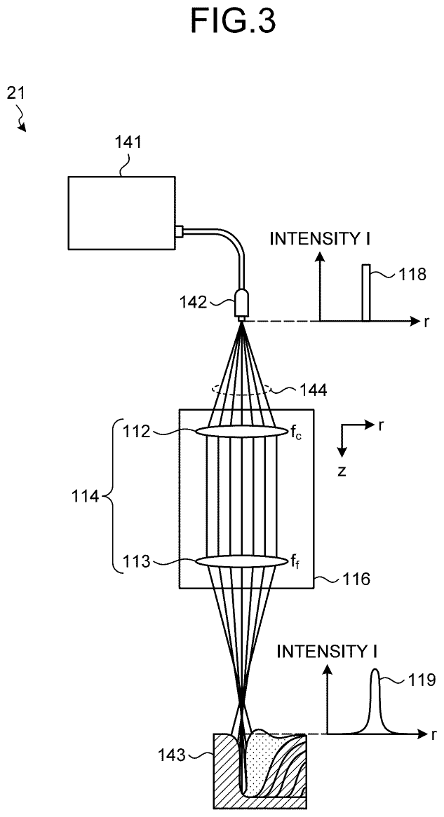

Next, configurations of the laser machining apparatus according to the first embodiment will be described. In the first embodiment, three exemplary configurations will be described. FIG. 3 is a diagram illustrating a configuration of a laser machining apparatus 21 according to a first example of the first embodiment. The laser machining apparatus 21 locally melts a workpiece by irradiation with laser light to machine the workpiece. The laser machining apparatus 21 performs laser machining such as cutting, welding, or heat treatment.

The laser machining apparatus 21 includes a laser oscillator 141 as a light source, an optical fiber 142 as a transmission path of laser light 144, and a laser machining head 116. The laser machining head 116 includes the collimator lens 112 and the condenser lens 113 through which laser light propagates. Hereinafter, the optical system including the collimator lens 112 and the condenser lens 113 is referred to as a machining optical system 114.

The laser oscillator 141 is a laser that outputs the laser light 144 in a near infrared region, such as a fiber laser, a YAG laser, or a DDL. The YAG laser may be a disk laser using a disk-shaped medium. The laser oscillator 141 has, for example, an output of a kilowatt class that allows for machining of metal or the like. The laser output of the laser oscillator 141 is typically 1 kw, and is desirably 4 kW or more in the case of machining a thick metal or the like. The laser output of the laser oscillator 141 may be 10 kW or more.

The laser light 144 output from the laser oscillator 141 propagates through the optical fiber 142. The optical fiber 142 is, for example, an optical fiber through which the laser light 144 of a kilowatt class can propagate. The intensity distribution of the beam at the emission end of the optical fiber 142 is, for example, a top-hat shape. The core diameter φ₀ of the optical fiber 142 is, for example, 50 μm, 100 μm, 150 μm, 200 μm, or 300 μm. A profile 118 is a beam profile of the laser light 144 at the emission end of the optical fiber 142. A profile 119 is a beam profile of the laser light 144 that enters the workpiece 143.

The laser light 144 emitted from the optical fiber 142 diverges. A beam parameter product (BPP) is represented as we by the divergence angle θ of the laser light 144 and a beam waist radius ω₀. When the beam profile at the emission end of the optical fiber 142 is a top-hat shape, the beam waist radius ω₀ is φ₀/2. Therefore, the expression BPP=φ₀θ/2 can hold.

The BPP of the laser light 144 output from the optical fiber 142 may differ between types of laser oscillators 141. In addition, the BPP of the laser light 144 output from the optical fiber 142 may differ between individuals of laser oscillators 141 of the same type. When the core diameter φ₀ is 100 μm, the BPP is, for example, about 2.5 mm·mrad to 5.5 mm·mrad. When the core diameter φ₀ is 200 μm, the BPP is, for example, about 5.0 mm·mrad to 11.0 mm·mrad. These ranges of BPP correspond to the divergence angles θ from 50 mrad to 110 mrad.

The machining optical system 114 illustrated in FIG. 3 causes aberration. The collimator lens 112 is disposed at a position where the distance from the emission end of the optical fiber 142 is f_{c}. The laser light 144 having passed through the collimator lens 112 passes through the condenser lens 113 and is collected at the workpiece 143.

The distance f_{c} which is the focal length of the collimator lens 112 and the distance f_{f} which is the focal length of the condenser lens 113 are each, for example, about 50 mm to 600 mm. When the distance f_{c} and the distance f_{f} are converted into the refractive power that is the reciprocal of the focal length, each of the refractive power of the collimator lens 112 and the refractive power of the condenser lens 113 is about 1.67D to 20D. D is diopter, a unit of refractive power, and is represented by m⁻¹ in the SI basic unit. For example, in a case where the distance f_{c} is 200 mm and the distance f_{f} is 200 mm, the machining optical system 114 having an optical magnification of one time is configured. In a case where the distance f_{c} is 200 mm and the distance f_{f} is 400 mm, the machining optical system 114 having an optical magnification of two times is configured. Furthermore, by changing the combination of the focal length of the collimator lens 112 and the focal length of the condenser lens 113, the machining optical system 114 having other optical magnifications can also be configured.

Each of the collimator lens 112 and the condenser lens 113 is not limited to a single lens, and may be configured by two or more lenses. In this case, the focal length of the collimator lens 112 is the combined focal length of the combination of two or more lenses. The focal length of the condenser lens 113 is the combined focal length of the combination of two or more lenses.

The workpiece 143 is, for example, a metal product made of metal such as mild steel, copper, aluminum, stainless steel, or galvanized steel. The metal product may be a metal component, a metal plate, or the like. For example, the laser machining apparatus 21 that performs laser welding may irradiate each of a first metal product and a second metal product with the laser light 144, and perform laser welding using an existing weld joint such as butt welding, fillet welding, or lap welding. Each of the first metal product and the second metal product is the workpiece 143 in laser welding. The laser machining apparatus 21 can manufacture a third metal product in which the first metal product and the second metal product are joined by laser welding between the first metal product and the second metal product.

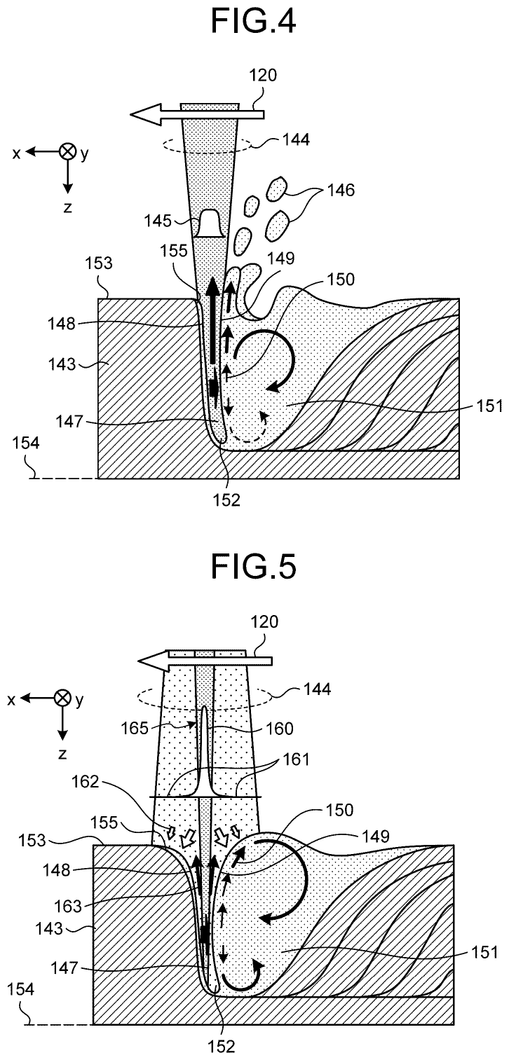

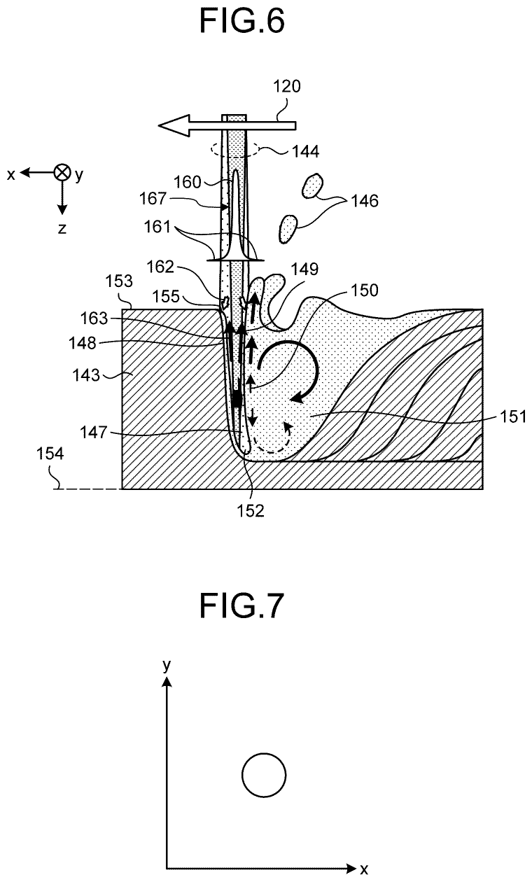

Next, the relationship between the state of laser machining and aberration in the first embodiment will be described. FIG. 4 is a first diagram for explaining the relationship between the state of laser machining and aberration in the first embodiment. FIG. 5 is a second diagram for explaining the relationship between the state of laser machining and aberration in the first embodiment. FIG. 6 is a third diagram for explaining the relationship between the state of laser machining and aberration in the first embodiment.

FIGS. 4 to 6 schematically illustrate a state in which machining of the workpiece 143 is performed by irradiating the workpiece 143 with the laser light 144. FIG. 4 illustrates an example of a case where the laser light 144 is collected using the machining optical system 114 that does not cause aberration. The machining optical system 114 may be an optical system that causes negligibly small aberration. FIGS. 5 and 6 illustrate an example of a case where the laser light 144 is collected using the machining optical system 114 that causes aberration. FIG. 6 illustrates a state in which the absolute value of the lateral aberration is smaller than that in the state illustrated in FIG. 5. Note that illustration of the machining optical system 114 is omitted in FIGS. 4 to 6. The x direction and the y direction are directions perpendicular to each other and perpendicular to the z direction. A progress direction 120 is the progress direction of machining on the workpiece 143. The progress direction 120 can also be said to be the scanning direction of the laser light 144 on the workpiece 143. In FIGS. 4 to 6, the progress direction 120 is the x direction.

As illustrated in FIG. 4, when the machining optical system 114 that does not cause aberration is used, the profile 119 at the irradiation position of the laser light 144 in the workpiece 143 is a top-hat profile 145 obtained by enlarging the profile 118 at the emission end of the optical fiber 142 at the optical magnification M=f_{f}/f_{c}.

FIG. 7 is a diagram illustrating the beam shape of the laser light 144 illustrated in FIG. 4. The beam shape illustrated in FIG. 7 is the beam shape, on the xy plane, of the laser light 144 entering the workpiece 143. The beam shape of the laser light 144 entering the workpiece 143 is circular as illustrated in FIG. 7.

When the intensity I of the laser light 144 having the top-hat profile 145 is, for example, 200 kW/cm² or more, the workpiece 143 is melted by the radiated laser light 144, and a keyhole 147 is formed in the workpiece 143. At this time, each of a front wall 148 and a rear wall 149 of the keyhole 147 is nearly perpendicular to a reference surface 154 from a bottom 152 of the keyhole 147 to an opening 155 on a surface 153 of the workpiece 143. The front wall 148 is the wall of the keyhole 147 located front in the progress direction 120. The rear wall 149 is the wall of the keyhole 147 located rear in the progress direction 120. The surface 153 is the surface of the workpiece 143 that the laser light 144 enters. The reference surface 154 is a surface perpendicular to the central axis of the machining optical system 114, and is, for example, a surface on which the workpiece 143 is placed. In a state where the workpiece 143 is placed on the reference surface 154, the surface 153 is parallel to the reference surface 154.

In FIG. 4, a molten metal flow 150, which is the flow of molten metal 151, rises at a high rate along the rear wall 149 from the bottom 152 toward the opening 155. The molten metal flow 150 causes a part of the molten metal 151 to be scattered as a spatter 146. Therefore, as illustrated in FIG. 4, in a case where the machining optical system 114 that does not cause aberration is used, machining may become unstable due to generation of the spatter 146.

As illustrated in FIG. 5, when the machining optical system 114 that causes aberration is used, the profile 119 at the irradiation position of the laser light 144 in the workpiece 143 is a witch-hat profile 165 having a main beam 160 at the center and a peripheral beam 161 surrounding the main beam 160.

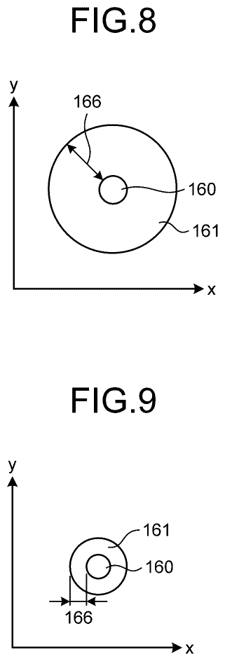

FIG. 8 is a diagram illustrating the beam shape of the laser light 144 illustrated in FIG. 5. The beam shape illustrated in FIG. 8 is the beam shape, on the xy plane, of the laser light 144 entering the workpiece 143. The beam shape of the laser light 144 entering the workpiece 143 is a concentric circle of a circle of the main beam 160 and a circle of the peripheral beam 161. A peripheral beam width 166 is a width between the circle of the peripheral beam 161 and the circle of the main beam 160.

In the case illustrated in FIG. 5, the absolute value of the lateral aberration generated at the paraxial focus 117 of the laser light 144 having passed through the machining optical system 114 is, for example, 0.2 mm or more. In the following description, the paraxial focus 117 of the laser light 144 having passed through the machining optical system 114 is simply referred to as the paraxial focus 117 of the machining optical system 114. The paraxial focus 117 of the laser light 144 that has passed through the laser machining head 116 is simply referred to as the paraxial focus 117 of the laser machining head 116.

When the intensity I of the laser light 144 having the witch-hat profile 165 is, for example, 200 kW/cm² or more, the workpiece 143 is melted by the radiated main beam 160, and the keyhole 147 is formed in the workpiece 143. In this case, the intensity I of the peripheral beam 161 is, for example, about 50 KW/cm² to 200 kW/cm². Note that the intensity I of the peripheral beam 161 may be any intensity as long as the keyhole 147 is not formed.

The molten metal 151 is evaporated from the surface of the molten metal 151 by the irradiation of the peripheral beam 161, thereby generating metal vapor 163. An evaporation reaction force 162 due to the generation of the metal vapor 163 acts from the surface of the molten metal 151 toward the inside of the workpiece 143 in the opening 155 of the keyhole 147. Due to the action of the evaporation reaction force 162, at the rear in the progress direction 120, the molten metal flow 150 rising along the rear wall 149 changes from a direction perpendicular to the surface 153 to a direction parallel to the surface 153. Such a change in the molten metal flow 150 causes the opening 155 to expand in a horn shape. By expanding the opening 155 in a horn shape, the molten metal flow 150 is directed from the surface 153 to the inside of the workpiece 143. The molten metal flow 150 stabilizes the keyhole 147 and reduces scattering of a part of the molten metal 151 as the spatter 146.

In the keyhole 147, the metal vapor 163 easily escapes from the front wall 148 to the opening 155 by expanding the opening 155 in a horn shape. As the metal vapor 163 easily escapes, the keyhole 147 is stabilized, and scattering of a part of the molten metal 151 as the spatter 146 is reduced. In this way, in the case of the machining illustrated in FIG. 5, stable machining can be performed by stabilizing the keyhole 147 and reducing the spatter 146.

In the case illustrated in FIG. 6, the machining optical system 114 that causes aberration is used, but the absolute value of the caused lateral aberration is smaller than that in the case illustrated in FIG. 5. The profile 119 at the irradiation position of the laser light 144 in the workpiece 143 is a witch-hat profile 167 having the main beam 160 at the center and the peripheral beam 161 surrounding the main beam 160.

FIG. 9 is a diagram illustrating the beam shape of the laser light 144 illustrated in FIG. 6. The beam shape illustrated in FIG. 9 is the beam shape, on the xy plane, of the laser light 144 entering the workpiece 143. The beam shape of the laser light 144 entering the workpiece 143 is a concentric circle of a circle of the main beam 160 and a circle of the peripheral beam 161. The peripheral beam width 166 illustrated in FIG. 9 is smaller than the peripheral beam width 166 illustrated in FIG. 8.

In the case illustrated in FIG. 6, the absolute value of the lateral aberration generated at the paraxial focus 117 of the laser light 144 having passed through the machining optical system 114 is smaller than 0.2 mm, for example. In the laser light 144 having the witch-hat profile 167 illustrated in FIG. 6, since the peripheral beam width 166 is smaller than that in the case illustrated in FIG. 5, the opening 155 cannot be expanded in a horn shape. For this reason, in the case illustrated in FIG. 6, although the aberration is caused by the machining optical system 114 and the peripheral beam 161 is formed, the scattering of the spatter 146 cannot be reduced as compared with the case illustrated in FIG. 5. In this way, as illustrated in FIG. 6, when the absolute value of the generated lateral aberration is smaller than that in the case illustrated in FIG. 5, machining may become unstable due to generation of the spatter 146.

As described with reference to FIGS. 4 to 6, when the amount of aberration caused by the machining optical system 114 changes, the beam shape of the laser light 144 at the irradiation position changes, so that machining stability can change. Therefore, if a certain amount of aberration can be generated, the beam shape is stabilized, and stable machining can be realized.

As described above, the divergence angle of the laser light 144 at the emission end of the optical fiber 142 is, for example, 50 mrad to 100 mrad. In addition, the divergence angle of the laser light 144 may differ between types of laser oscillators 141, and may differ between individuals of laser oscillators 141 of the same type. As illustrated in FIG. 1, the lateral aberration caused by the spherical aberration changes depending on the divergence angle of the laser light 144. Therefore, even with the use of the same machining optical system 114, the beam shape at the irradiation position may vary due to the change in lateral aberration between types of laser oscillators 141 or between individuals of laser oscillators 141. Such a change in the beam shape may change the machining state of the laser machining apparatus 21 and may also change the machining quality of the laser machining apparatus 21.

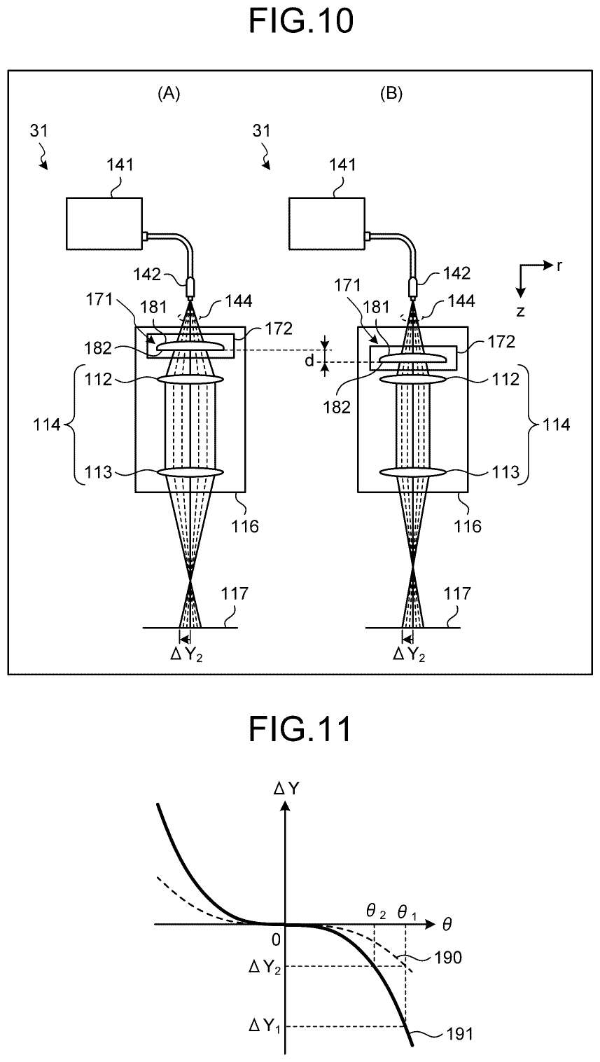

FIG. 10 is a diagram illustrating a configuration of a laser machining apparatus 31 according to a second example of the first embodiment. The laser machining apparatus 31 includes an aberration optical system that causes aberration in addition to the components similar to those of the laser machining apparatus 21 illustrated in FIG. 3. In the second example, the aberration optical system is an aberration lens 171 that is a single lens. The aberration lens 171 is a convex lens having a convex surface that is an aspherical surface.

The laser machining head 116 includes the aberration lens 171, the collimator lens 112, and the condenser lens 113. In addition, the laser machining head 116 includes a movable mechanism 172 that moves the aberration lens 171 in the direction of the optical axis. The laser machining apparatus 31 includes a control device that controls the movable mechanism 172. In the second example, the machining optical system 114 is an optical system that does not cause aberration. The machining optical system 114 may be an optical system that causes negligibly small aberration. In FIG. 10, illustration of the workpiece 143 and the control device is omitted.

The aberration lens 171 is disposed on the optical path of the laser light 144 between the emission end of the optical fiber 142 and the collimator lens 112. The aberration lens 171 is disposed at a position within a range in which the laser light 144 spreads in the propagation direction of the laser light 144 emitted toward the workpiece 143, that is, in the direction approaching the workpiece 143. The aberration lens 171 causes lateral aberration.

FIGS. 10(A) and (B) illustrate a difference in behavior of the laser light 144 in a case where the laser light 144 having different divergence angles is emitted from the emission end of the optical fiber 142. FIG. 10(B) illustrates a state in which the divergence angle of the laser light 144 emitted from the emission end of the optical fiber 142 is smaller than that in the case illustrated in FIG. 10(A). In the state illustrated in FIG. 10(B), the laser machining apparatus 31 moves the aberration lens 171 by a movement amount d in the direction approaching the workpiece 143 as compared with the state illustrated in FIG. 10(A).

When the divergence angle of the laser light 144 changes, the laser machining apparatus 31 can maintain the lateral aberration generated at the paraxial focus 117 of the laser machining head 116 at a constant lateral aberration ΔY₂ by changing the position of the aberration lens 171 in the z direction. The laser machining apparatus 31 reduces the change in the beam shape at the irradiation position between types of laser oscillators 141 or between individuals of laser oscillators 141 by maintaining the lateral aberration. Consequently, the laser machining apparatus 31 can realize stable machining.

FIG. 11 is a diagram for explaining a change in lateral aberration caused by moving the aberration lens 171 in the second example of the first embodiment. FIG. 11 is a graph illustrating the relationship between the lateral aberration ΔY and the divergence angle θ. In FIG. 11, a broken line 190 indicates the relationship between the lateral aberration and the divergence angle in the case illustrated in FIG. 10(A). In FIG. 11, a solid line 191 indicates the relationship between the lateral aberration and the divergence angle in the case illustrated in FIG. 10(B).

In the case illustrated in FIG. 10(A), the divergence angle θ of the laser light 144 emitted from the emission end of the optical fiber 142 is θ₁. In the case illustrated in FIG. 10(B), the divergence angle θ of the laser light 144 emitted from the emission end of the optical fiber 142 is θ₂. Here, θ₁>θ₂. The lateral aberration ΔY generated in both the case illustrated in FIG. 10(A) and the case illustrated in FIG. 10(B) is ΔY₂.

As described with reference to FIG. 2, the lateral aberration ΔY is proportional to the cube of the divergence angle θ. Given a proportionality constant α₁, ΔY=α₁θ³ holds. That is, the dependency of the lateral aberration ΔY generated by the aberration lens 171 on the divergence angle θ is similar to the case of the spherical aberration. The proportionality constant α₁ is changed by moving the aberration lens 171 in the direction of the optical axis. As the proportionality constant of changes, the lateral aberration ΔY becomes the same ΔY₂ regardless of whether the divergence angle θ is θ₁ or θ₂. That is, even when the divergence angle θ changes from θ₁ to θ₂, the lateral aberration ΔY is maintained at ΔY₂.

In the laser machining head 116 illustrated in FIG. 10, the aberration lens 171 is disposed on the optical path on which the laser light 144 emitted from the emission end of the optical fiber 142 is diverged. The collimator lens 112 is disposed on the optical path of the laser light 144 that has passed through the aberration lens 171. The condenser lens 113 is disposed on the optical path of the laser light 144 that has passed through the collimator lens 112.

The aberration lens 171 is not limited to the one disposed on the optical path on which the laser light 144 is diverged between the emission end of the optical fiber 142 and the collimator lens 112. The aberration lens 171 may be disposed on the optical path on which the laser light 144 is collected between the condenser lens 113 and the workpiece 143. In this case, the collimator lens 112 is disposed on the optical path on which the laser light 144 emitted from the emission end of the optical fiber 142 is diverged. The condenser lens 113 is disposed on the optical path of the laser light 144 that has passed through the collimator lens 112. The aberration lens 171 is disposed on the optical path of the laser light 144 that has passed through the condenser lens 113.

The laser machining head 116 can change the lateral aberration at the paraxial focus 117 of the laser machining head 116 by moving the aberration lens 171 in the direction of the optical axis on the optical path of the diverged or collected laser light 144. Here, “diverged” means that the beam diameter increases as the laser light 144 propagates. In addition, “collected” means that the beam diameter decreases as the laser light 144 propagates.

As illustrated in FIG. 10, the position of the aberration lens 171 is separated from the irradiation position of the laser light 144 by disposing the aberration lens 171 on the optical path on which the laser light 144 is diverged. As the position of the aberration lens 171 is separated from the irradiation position of the laser light 144, the spatter 146 is prevented from adhering to the aberration lens 171 when the spatter 146 scatters from the workpiece 143. Consequently, the laser machining apparatus 31 can prevent the aberration lens 171 from being damaged by the laser light 144 passing through the aberration lens 171 with the adhering spatter 146.

The laser machining apparatus 31 may include a protective plate for protecting the machining optical system 114 and the aberration lens 171 from damage due to adhering of the spatter 146. The protective plate is disposed on the optical path of the laser light 144 between the condenser lens 113 and the workpiece 143. The protective plate is made of a material transparent to the laser light 144 and allows the laser light 144 to pass therethrough. In addition, in order to protect the machining optical system 114 and the aberration lens 171, a protective plate may be disposed on the optical path of the laser light 144 between the emission end of the optical fiber 142 and the aberration lens 171.

The aberration lens 171 is, for example, a plano-convex aspherical lens having a first surface 181 that is an aspherical and convex surface and a second surface 182 that is a flat surface. In the laser machining apparatus 31 illustrated in FIG. 10, the first surface 181 is an incident surface on which the laser light 144 is incident, and the second surface 182 is an emission surface from which the laser light 144 is emitted. Alternatively, the first surface 181 may be the emission surface of the laser light 144, and the second surface 182 may be the incident surface of the laser light 144.

In general, the shape of an aspherical surface is defined by a sag amount, i.e. a cutting amount in the direction of the central axis of the lens. The sag amount z(r) is expressed by Formula (1) below.

$$\begin{matrix}Formula 1 & \\ z ( r ) = \frac{{C}_{0} {r}^{2}}{1 + \sqrt{1 - ( 1 + k ) {C}_{0}^{2} {r}^{2}}} + {A}_{4} {r}^{4} + {A}_{6} {r}^{6} + {A}_{8} {r}^{8} & ( 1 )\end{matrix}$$

Here, C₀ is a curvature C on the central axis, k is a conic constant, and Aⱼ is an aspherical coefficient. In addition, j is an even number of four or more. The curvature C is defined by Formula (2) below.

$$\begin{matrix}Formula 2 & \\ C = \frac{{z}^{″} ( r )}{{\{ 1 + {[ {z}^{′} ( r ) ]}^{2} \}}^{3 / 2}} & ( 2 )\end{matrix}$$

Here, z′(r)=dz/dr and z″(r)=d²z/dr² hold. C₀ is the curvature C in the case r=0. In a case where the first surface 181 is an aspherical surface having C₀ of a non-zero value and the second surface 182 is a flat surface, the position of the paraxial focus 117 of the laser machining head 116 also moves in the direction of the optical axis along with the movement of the aberration lens 171 in the direction of the optical axis. Therefore, the first surface 181 of the aberration lens 171 may be an aspherical surface with C₀=0. From Formula (1), the sag amount z(r) in the case C₀=0 is expressed by Formula (3) below.

$$\begin{matrix}Formula 3 & \\ z ( r ) = {A}_{4} {r}^{4} + {A}_{6} {r}^{6} + {A}_{8} {r}^{8} & ( 3 )\end{matrix}$$

If the first surface 181 is an aspherical surface having a shape represented by Formula (3) with C₀=0 and the second surface 182 is a flat surface, the position of the paraxial focus 117 of the laser machining head 116 does not move even when the aberration lens 171 is moved in the direction of the optical axis. The laser machining apparatus 31 can keep the irradiation position of the laser light 144 constant by not moving the position of the paraxial focus 117 of the laser machining head 116. In addition, for example, in a case where the aspherical shapes of the sixth order or more are set to zero in Formula (3) and the terms up to A₄, which is the fourth order term, are used for the left side of Formula (3), the value of the aspherical coefficient A₄ in the aberration lens 171 is a positive value.

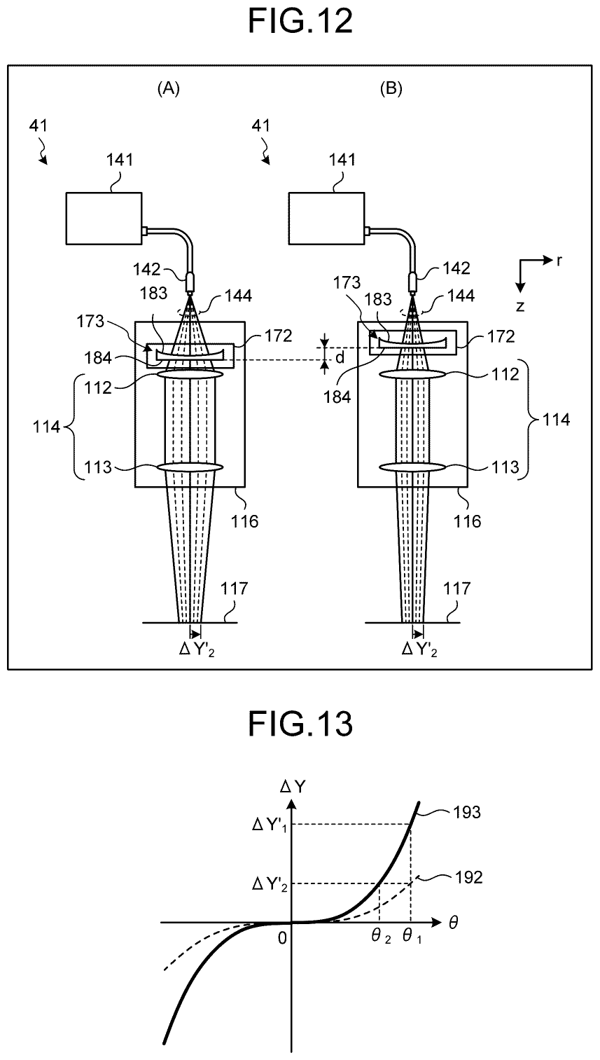

FIG. 12 is a diagram illustrating a configuration of a laser machining apparatus 41 according to a third example of the first embodiment. The laser machining head 116 includes an aberration lens 173, the collimator lens 112, and the condenser lens 113. In addition, the laser machining head 116 includes the movable mechanism 172 that moves the aberration lens 173 in the direction of the optical axis. The laser machining apparatus 41 includes a control device that controls the movable mechanism 172. In FIG. 12, illustration of the workpiece 143 and the control device is omitted.

The laser machining apparatus 41 is different from the laser machining apparatus 31 illustrated in FIG. 10 in that the aberration lens 173 is provided instead of the aberration lens 171. Except this, the laser machining apparatus 41 is similar to the laser machining apparatus 31. In the third example, the aberration optical system is the aberration lens 173 that is a single lens. The aberration lens 173 is a concave lens having a concave surface that is an aspherical surface. For example, in a case where the aspherical shapes of the sixth order or more are set to zero in Formula (3) and the terms up to A₄, which is the fourth order term, are used for the left side of Formula (3), the value of A₄ in the aberration lens 173 is a negative value.

FIGS. 12(A) and (B) illustrate a difference in behavior of the laser light 144 in a case where the laser light 144 having different divergence angles is emitted from the emission end of the optical fiber 142. FIG. 12(B) illustrates a state in which the divergence angle of the laser light 144 emitted from the emission end of the optical fiber 142 is smaller than that in the case illustrated in FIG. 12(A). In the state illustrated in FIG. 12(B), the laser machining apparatus 41 moves the aberration lens 173 by the movement amount d in the direction away from the workpiece 143 as compared with the state illustrated in FIG. 12(A).

When the divergence angle of the laser light 144 changes, the laser machining apparatus 41 can maintain the lateral aberration generated at the paraxial focus 117 of the laser machining head 116 at a constant lateral aberration ΔY′₂ by changing the position of the aberration lens 173 in the z direction. The laser machining apparatus 41 reduces the change in the beam shape at the irradiation position between types of laser oscillators 141 or between individuals of laser oscillators 141 by maintaining the lateral aberration. Consequently, the laser machining apparatus 41 can realize stable machining.

Note that the laser machining apparatus 31 of the second example illustrated in FIG. 10 moves the aberration lens 171 toward the emission end of the optical fiber 142 when the divergence angle increases, and moves the aberration lens 171 toward the collimator lens 112 when the divergence angle decreases. On the other hand, the laser machining apparatus 41 of the third example illustrated in FIG. 12 moves the aberration lens 173 toward the collimator lens 112 when the divergence angle increases, and moves the aberration lens 173 toward the emission end of the optical fiber 142 when the divergence angle decreases. Thus, the direction in which the aberration lens 173 is moved in the third example is opposite to the direction in which the aberration lens 171 is moved in the second example.

FIG. 13 is a diagram for explaining a change in lateral aberration caused by moving the aberration lens 173 in the third example of the first embodiment. FIG. 13 is a graph illustrating the relationship between the lateral aberration ΔY and the divergence angle θ. In FIG. 13, a broken line 192 indicates the relationship between the lateral aberration and the divergence angle in the case illustrated in FIG. 12(A). In FIG. 13, a solid line 193 indicates the relationship between the lateral aberration and the divergence angle in the case illustrated in FIG. 12(B).

In the case illustrated in FIG. 12(A), the divergence angle θ of the laser light 144 emitted from the emission end of the optical fiber 142 is θ₁. In the case illustrated in FIG. 12(B), the divergence angle θ of the laser light 144 emitted from the emission end of the optical fiber 142 is θ₂. Here, θ₁>θ₂. The lateral aberration ΔY generated in both the case illustrated in FIG. 12(A) and the case illustrated in FIG. 12(B) is ΔY′₂. Even when the divergence angle θ changes from θ₁ to θ₂, the lateral aberration ΔY is maintained at ΔY′₂ by moving the aberration lens 173 in the direction of the optical axis.

In the laser machining head 116 illustrated in FIG. 12, the aberration lens 173 is disposed on the optical path on which the laser light 144 emitted from the emission end of the optical fiber 142 is diverged. Note that the aberration lens 173 may be disposed on the optical path on which the laser light 144 is collected between the condenser lens 113 and the workpiece 143. As the position of the aberration lens 173 is separated from the irradiation position of the laser light 144, the spatter 146 is prevented from adhering to the aberration lens 173. Consequently, the laser machining apparatus 41 can prevent the aberration lens 173 from being damaged by the laser light 144 passing through the aberration lens 173 with the adhering spatter 146. In addition, the laser machining apparatus 41 may include a protective plate for protecting the machining optical system 114 and the aberration lens 171 from damage due to adhering of the spatter 146. In the laser machining apparatus 41, a protective plate may be disposed on the optical path of the laser light 144 between the emission end of the optical fiber 142 and the aberration lens 171.

The aberration lens 173 is, for example, a plano-concave aspherical lens having a first surface 183 that is an aspherical and concave surface and a second surface 184 that is a flat surface. In the laser machining apparatus 41 illustrated in FIG. 12, the first surface 183 is the incident surface of the laser light 144, and the second surface 184 is the emission surface of the laser light 144. Alternatively, the first surface 183 may be the emission surface of the laser light 144, and the second surface 184 may be the incident surface of the laser light 144.

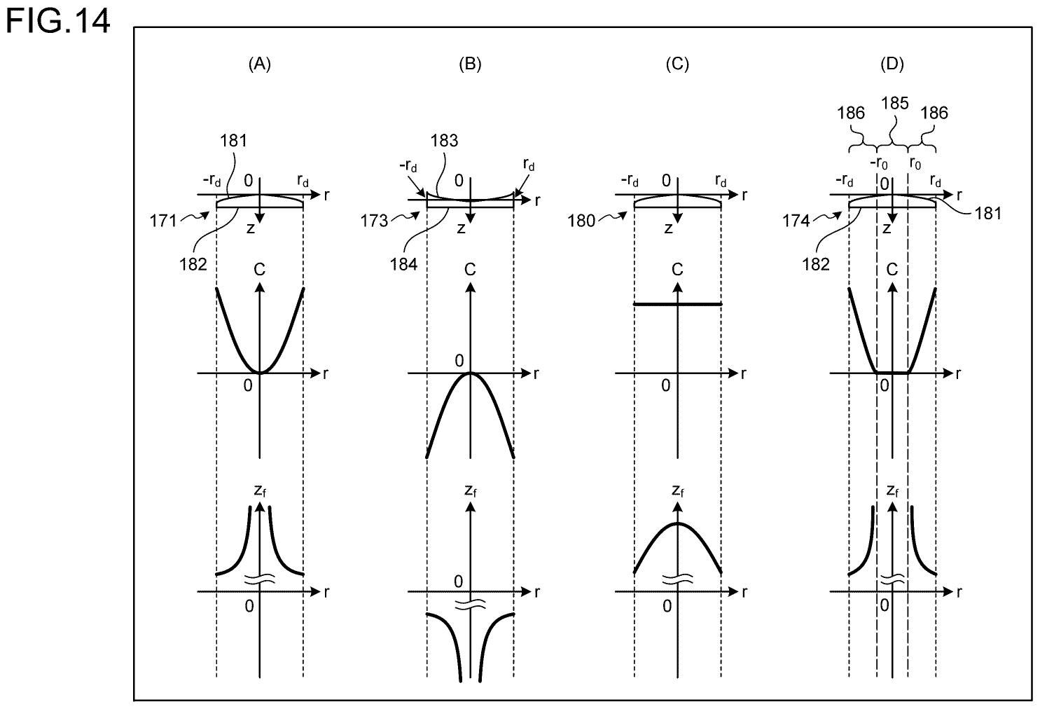

FIG. 14 is a diagram for explaining a configuration of the aberration optical system in the first embodiment. FIGS. 14(A) and (B) illustrate examples of the shape of the aberration lenses 171 and 173, which are the aberration optical system, the curvature C of the aspherical surface on the aberration lenses 171 and 173, and the focal position z_{f} of the aberration lenses 171 and 173. In FIG. 14, the shape of the aberration lens indicates the shape of a cross section including the r direction and the z direction. For the curvature C, a graph representing the relationship between the position in the r direction and the curvature C is shown. For the focal position z_{f}, a graph representing the relationship between the position in the r direction and the focal position z_{f} is shown. Note that the position in the r direction is represented by the r coordinate that is based on the position of the central axis. Further, the r coordinate is simply referred to as “r”.

The focal position z_{f} is a position in the z direction at which the light ray bent by the aberration lens intersects the central axis when the light ray traveling in the direction of the central axis enters the aberration lens disposed at the position of z=0. For example, in a case where a thin lens which is a convex lens and has a focal length f is disposed at a position of z=0, z_{f}=f holds. In a case where a thin lens which is a concave lens and has a focal length −f is disposed at a position of z=0, z_{f}=−f holds. In the lens that causes aberration, the focal position z_{f} changes depending on the distance between the light ray parallel to the central axis and the central axis. The focal position z_{f} of the lens that causes the aberration changes depending on the distance between the light ray in the direction of the central axis and the central axis. FIG. 14 illustrates an example of a change in the focal position z_{f} in a case where the position on which the light ray in the direction of the central axis is incident is changed in the r direction with respect to the focal position z_{f}.

FIG. 14(A) illustrates an example of the shape, curvature C, and focal position z_{f} of the aberration lens 171 illustrated in FIG. 10. FIG. 14(B) illustrates an example of the shape, curvature C, and focal position z_{f} of the aberration lens 173 illustrated in FIG. 12. In FIG. 14(C), examples of the shape, curvature C, and focal position z_{f} of a plano-convex spherical lens 180 are illustrated for comparison with the aberration lens 171. The curvature C of the plano-convex spherical lens 180 is constant regardless of r. On the other hand, the curvature C of the aberration lens 171 monotonously increases as the absolute value of r increases. The curvature C of the aberration lens 173 monotonously decreases as the absolute value of r increases. That is, in the aberration lens 171, the curvature C monotonously increases with increasing distance from the central axis in the radial direction. In the aberration lens 173, the curvature C monotonously decreases with increasing distance from the central axis in the radial direction.

The focal position z of the aberration lens 171 increases as the absolute value of r decreases. In the aberration lens 171, the focal position z_{f} for the light ray on the central axis is positive infinity. That is, the aberration lens 171 has no refractive power with respect to the light ray on the central axis. The focal position z_{f} of the aberration lens 173 decreases as the absolute value of r decreases. In the aberration lens 173, the focal position z_{f} for the light ray on the central axis is negative infinity. That is, the aberration lens 173 has no refractive power with respect to the light ray on the central axis. Note that the phrase “having no refractive power with respect to the light ray on the central axis” includes a state in which the refractive power with respect to the light ray on the central axis is negligibly small.

In summary, in each of the aberration lenses 171 and 173, the absolute value |z_{f}| of the focal position z_{f} decreases as the absolute value |r| of r increases. |z_{f}| is the distance between the aberration lens 171 and the focal point, or the distance between the aberration lens 173 and the focal point. |r| represents the distance between the central axis and a light ray parallel to the central axis. In other words, the aberration lenses 171 and 173 have a light collecting characteristic in which when a light ray parallel to the central axis is incident on the aberration lenses 171 and 173, the light ray at a position farther from the central axis has a shorter distance between the aberration lenses 171 and 173 and the focal point. Consequently, the aberration lenses 171 and 173 cause aberration.

In the plano-convex spherical lens 180, |z_{f}| decreases as |r| increases. However, the plano-convex spherical lens 180 is different from the aberration lens 171 in that the focal position z_{f} for the light ray on the central axis is finite. The focal position z_{f} of the plano-convex spherical lens 180 is, for example, a quadratic function of r.

When the aberration lenses 171 and 173 are actually manufactured, the refractive power on the central axis cannot be completely zero. For this reason, the aberration lenses 171 and 173 may have refractive power on the central axis as long as the position of the paraxial focus 117 of the laser machining head 116 does not change significantly. The absolute value of the refractive power on the central axis of the aberration lenses 171 and 173 is, for example, 1/10 or less of the refractive power of the collimator lens 112. The absolute value of the refractive power on the central axis of the aberration lenses 171 and 173 may be 1/100 or less of the refractive power of the collimator lens 112.

Given that the focal length f_{c} of the collimator lens 112 is 200 mm, the refractive power of the collimator lens 112 corresponds to 5D. Therefore, the absolute value of the refractive power on the central axis of the aberration lenses 171 and 173 is, for example, 0.5D or less corresponding to 1/10 or less of 5D. The absolute value of the refractive power on the central axis of the aberration lenses 171 and 173 may be 0.05D or less corresponding to 1/100 or less of the refractive power of the collimator lens 112.

As described above, the position on the central axis of the aberration lenses 171 and 173 is such that there is no refractive power, or that the absolute value of the refractive power is 1/10 or less or 1/100 or less of the refractive power of the collimator lens 112. The aberration lenses 171 and 173 can prevent the position of the paraxial focus 117 of the laser machining head 116 from greatly changing at the position on the central axis.

FIG. 14(D) illustrates an example of the shape, curvature C, and focal position z_{f} of the aberration lens 174. The aberration lens 174 is different from the aberration lens 171 in having an aspherical surface in which a center region 185 has a curvature of zero. Except this, the aberration lens 174 is similar to the aberration lens 171. The laser machining apparatus 31 illustrated in FIG. 10 may include the aberration lens 174 instead of the aberration lens 171. The aberration lens 174 is an aberration optical system provided in the laser machining head 116, and is a single lens.

In the aberration lens 174, the center region 185 is a region including a position on the central axis. A peripheral region 186 is a region surrounding the center region 185. The lens radius of the aberration lens 174 is set to r_{d}, and r indicating a boundary between the center region 185 and the peripheral region 186 is set to a boundary value r₀. Here, r₀ is a positive real number. The center region 185 is a region in the range of −r₀≤r≤r₀ in a direction perpendicular to the central axis. The peripheral region 186 is a region in the range of −r_{d}≤r<−r₀ or r₀<r≤rₛ in a direction perpendicular to the central axis. That is, the center region 185 is a region where the distance from the central axis is equal to or less than the boundary value r₀. The peripheral region 186 is a region where the distance from the central axis exceeds the boundary value r₀.

In the aberration lens 171 illustrated in FIG. 14(A), the curvature is zero at the position on the central axis, whereas in the aberration lens 174, the curvature is zero in the center region 185 of −r₀≤r≤r₀. The aberration lens 174 can be easily created by setting the curvature of the center region 185 to zero, that is, setting the center region 185 to a flat surface. The curvature of the peripheral region 186 monotonically increases as the absolute value |r| of r increases. That is, in the peripheral region 186, the curvature monotonically increases with increasing distance from the central axis in the radial direction.

The boundary value r₀ is, for example, a value equal to or less than 50% of the lens radius r_{d}. The boundary value r₀ may be a value of 40% or less of the lens radius r_{d} or a value of 30% or less of the lens radius r_{d}. The aberration lens 174 is obtained by replacing the center region of the aberration lens 171 with the center region 185 having a curvature of zero. The aberration lens 174 has no refractive power in the center region 185, and |z_{f}| decreases as |r| increases in the peripheral region 186. Note that the aberration lens 174 may be obtained by replacing the center region of the aberration lens 173 illustrated in FIG. 14(B) with the center region 185 having a curvature of zero.

When the aberration lens 174 is actually manufactured, the refractive power in the center region 185 cannot be completely zero. For this reason, the aberration lens 174 may have refractive power in the center region 185 as long as the position of the paraxial focus 117 of the laser machining head 116 does not change significantly. The absolute value of the refractive power in the center region 185 of the aberration lens 174 is, for example, 1/10 or less of the refractive power of the collimator lens 112. The absolute value of the refractive power in the center region 185 of the aberration lens 174 may be 1/100 or less of the refractive power of the collimator lens 112.

Given that the focal length f_{c} of the collimator lens 112 is 200 mm, the refractive power of the collimator lens 112 corresponds to 5D. Therefore, the absolute value of the refractive power in the center region 185 of the aberration lens 174 is, for example, 0.5D or less corresponding to 1/10 or less of 5D. The absolute value of the refractive power in the center region 185 of the aberration lens 174 may be 0.05D or less corresponding to 1/100 or less of the refractive power of the collimator lens 112.

As described above, the center region 185 of the aberration lens 174 is such that there is no refractive power, or that the absolute value of the refractive power is 1/10 or less or 1/100 or less of the refractive power of the collimator lens 112. The aberration lens 174 can prevent the position of the paraxial focus 117 of the laser machining head 116 from greatly changing in the center region 185.

The peripheral region 186 of the aberration lens 174 has a light collecting characteristic in which when a light ray parallel to the central axis is incident on the peripheral region 186, the light ray at a position farther from the central axis has a shorter distance between the aberration lens 174 and the focal point of the light ray. The aberration lens 174 can generate aberration by the peripheral region 186. Note that the description on the aspherical surface of the aberration lens 171 also applies to the portion of the peripheral region 186 on the incident surface or the emission surface of the aberration lens 174.

In the above description, the aberration lens 174 is obtained by deforming the aberration lens 171 so as to include the center region 185 having a curvature of zero. The aberration lens 174 may be obtained by deforming the aberration lens 173 so as to include the center region 185 having a curvature of zero. In this case, the aberration lens 174 is different from the aberration lens 173 in having an aspherical surface in which the center region 185 has a curvature of zero. Except this, the aberration lens 174 is similar to the aberration lens 173. Note that the description on the aspherical surface of the aberration lens 173 also applies to the portion of the peripheral region 186 on the incident surface or the emission surface of the aberration lens 174. In the peripheral region 186, the curvature monotonously decreases with increasing distance from the central axis in the radial direction.

The movable mechanism 172 is, for example, a movable stage that is movable in the direction of the optical axis of the laser light 144. In order to control the movement of the movable stage with high accuracy, for example, a servo motor, a stepping motor, or the like may be mounted on the movable mechanism 172. The movable mechanism 172 may be any mechanism that can move in the direction of the optical axis of the laser light 144, and is not limited to the movable stage. The movable mechanism 172 may be a rotary helicoid structure, a straight helicoid structure, a cam structure, or the like.

The laser machining apparatuses 31 and 41 are not limited to those that move the aberration lenses 171, 173, and 174 with the movable mechanism 172. In the laser machining apparatuses 31 and 41, the lateral aberration ΔY at the paraxial focus 117 of the laser machining head 116 may be made constant by disposing the aberration lenses 171, 173, and 174 at an appropriate position on the optical axis of the laser light 144 according to the divergence angle of the laser light 144.

The aspherical coefficient of Formula (2) is determined such that the aspherical surface of the aberration lenses 171 and 173 or the portion of the peripheral region 186 of the aberration lens 174 has the shape indicated by Formula (2), and the lateral aberration ΔY at the paraxial focus 117 of the laser machining head 116 has the same value at the divergence angles θ₁ and θ₂. Consequently, by moving the aberration lenses 171, 173, and 174 in the direction of the optical axis, the laser machining apparatuses 31 and 41 can change only the dependency of the lateral aberration ΔY on the divergence angle while maintaining the position of the paraxial focus 117 of the laser machining head 116. When the laser light 144 having the divergence angle θ₁ is incident, the aberration lenses 171 and 174 move in the direction of the optical axis, so that the aberration lenses 171 and 174 can change the lateral aberration ΔY generated at the paraxial focus 117 of the laser machining head 116 from ΔY₂ to ΔY₁. When the laser light 144 having the divergence angle θ₁ is incident, the aberration lens 173 moves in the direction of the optical axis, so that the aberration lens 173 can change the lateral aberration ΔY generated at the paraxial focus 117 of the laser machining head 116 from ΔY′₂ to ΔY′₁.

Using such properties, the laser machining apparatuses 31 and 41 may change the lateral aberration generated at the paraxial focus 117 of the laser machining head 116 according to the workpiece 143, for example. For example, in a case where the workpiece 143 having a low absorption rate in the wavelength region of the laser oscillator 141 is machined, the laser machining apparatuses 31 and 41 may move the aberration lenses 171, 173, and 174 in the direction of the optical axis of the laser light 144 to further increase the lateral aberration at the paraxial focus 117 of the laser machining head 116. Examples of the material having a low absorption rate of the laser light 144 in the near infrared region include copper and aluminum. By increasing the lateral aberration at the paraxial focus 117 of the laser machining head 116, the laser machining apparatuses 31 and 41 can reduce the spatter 146 even in the case of machining the workpiece 143 having a low absorption rate of the laser light 144. Consequently, the laser machining apparatuses 31 and 41 can realize high-quality machining.

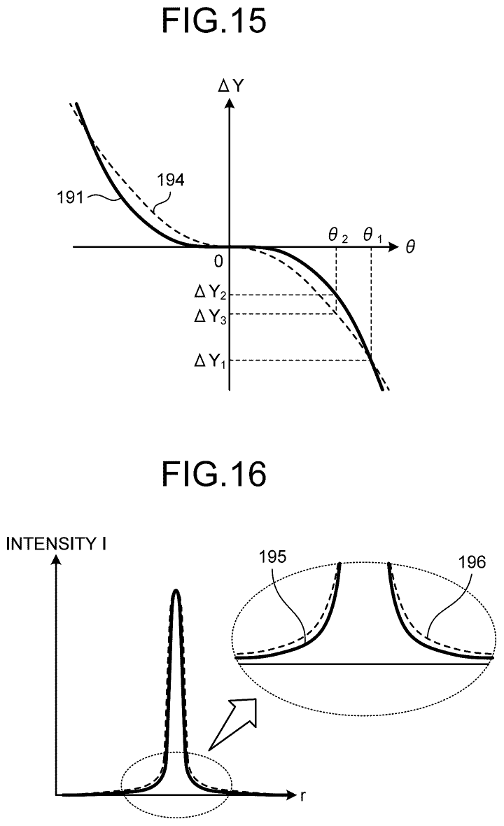

FIG. 15 is a diagram for explaining a change in the relationship between the lateral aberration and the divergence angle in a case where the aspherical shape of the aberration lens 171 is changed in the first embodiment. FIG. 15 is a graph illustrating the relationship between the lateral aberration ΔY and the divergence angle θ. The aspherical shape can be changed, for example, by changing the aspherical coefficient Aⱼ of Formula (1). In FIG. 15, the solid line 191 represents a case of applying an aspherical shape that causes the lateral aberration ΔY proportional to the cube of the divergence angle θ. That is, in the relationship indicated by the line 191, the aberration lens 171 causes a lateral aberration similar to the case of spherical aberration. In FIG. 15, a broken line 194 represents an example of a case of applying an aspherical shape in which the dependency of the lateral aberration ΔY on the divergence angle is different from that of the case of the line 191. The dependency of the lateral aberration ΔY on the divergence angle indicated by the line 194 is expressed by Formula (4) below. Here, α₂ is a constant, and β is a positive real number.

$$\begin{matrix}Formula 4 & \\ Δ Y = \{ \begin{matrix}{α}_{2} {θ}^{β} & ( θ \geq 0 ) \\ - {{α}_{2} ( - θ )}^{β} & ( θ < 0 )\end{matrix} & ( 4 )\end{matrix}$$

Given α₂=α₁ and β=3, Formula (4) is ΔY=α₁θ³. That is, the lateral aberration ΔY is proportional to the cube of the divergence angle θ. Hereinafter, the dependency of the lateral aberration ΔY on the divergence angle is the relationship expressed by Formula (4). The dependency of the lateral aberration ΔY on the divergence angle can be said to be that the lateral aberration ΔY is proportional to the β-power of the divergence angle θ, more generally, the lateral aberration ΔY is proportional to the power of the divergence angle θ. Hereinafter, α₂ is a proportionality constant, and β is a power index. The line 194 indicates an example of dependency of the lateral aberration ΔY on the divergence angle in a case where the value of the power index β is smaller than three, which is the value of the power index β in the case of the line 191. In this way, the lateral aberration ΔY at the paraxial focus 117 of the laser machining head 116 is proportional to the power of the divergence angle θ of the laser light 144.

In FIG. 15, the line 191 and the line 194 intersect when the divergence angle θ is θ₁. That is, when the divergence angle θ is θ₁, the lateral aberration ΔY is the same lateral aberration ΔY₁. When the divergence angle θ is θ₂ smaller than θ₁, the lateral aberration ΔY₃ indicated by the line 194 is smaller than the lateral aberration ΔY₂ indicated by the line 191.

FIG. 16 is a diagram for explaining a change in beam profile in a case where the aspherical shape of the aberration lens 171 is changed in the first embodiment. FIG. 16 illustrates the beam profile of the laser light 144 at the paraxial focus 117 of the laser machining head 116.

In FIG. 16, the beam profile in the relationship indicated by the line 191 in FIG. 15 is superimposed on the beam profile in the relationship indicated by the line 194 in FIG. 15. A profile 195 indicated by a solid line in FIG. 16 is a beam profile in the case of the relationship indicated by the line 191 in FIG. 15. A profile 196 indicated by a broken line in FIG. 16 is a beam profile in the case of the relationship indicated by the line 194 in FIG. 15. That is, the profile 195 is a beam profile in a case where the value of the power index β is three. The profile 196 is a beam profile in a case where the value of the power index β is smaller than three.

Each of the profiles 195 and 196 is a witch-hat beam profile. In addition, in FIG. 16, a portion corresponding to the peripheral beam 161 in each of the profiles 195 and 196 is enlarged in order to facilitate understanding of the difference between the profiles 195 and 196.

A significant difference between the profiles 195 and 196 is that the profile 196 has a higher intensity of the peripheral beam 161 than the profile 195. As a result, the peripheral beam width 166 illustrated in FIG. 8 is wider in the case of the profile 196 than in the case of the profile 195. In the case of the profile 196, for example, the opening 155 of the keyhole 147 in FIG. 6 can be expanded in a larger bellmouth shape. Therefore, the laser machining apparatuses 31 and 41 can obtain a higher reduction effect of the spatter 146, and can realize high-quality machining.

The above expression “bellmouth shape” will be described with reference to FIG. 6. The shape of the front wall 148 illustrated in FIG. 6 and the shape of the rear wall 149 illustrated in FIG. 6 expand from the bottom 152 toward the opening 155. The shape of the portion of the front wall 148 that rapidly expands in the vicinity of the opening 155 and the shape of the portion of the rear wall 149 that rapidly expands in the vicinity of the opening 155 can be likened to a known structure such as a bellmouth. The expression “bellmouth shape” does not limit the shape of the keyhole 147. The entire shape of the front wall 148 from the bottom 152 to the opening 155 and the entire shape of the rear wall 149 from the bottom 152 to the opening 155 can be likened to a known object such as a horn or a trumpet having a cylindrical portion that expands gently and an end portion that expands more rapidly than the cylindrical portion. Therefore, the entire keyhole 147 can be likened by using words such as a horn shape or a trumpet shape. Again, the word horn or trumpet does not limit the shape of the keyhole 147.

In summary, the laser machining apparatuses 31 and 41 can provide aberration larger than spherical aberration by making the lateral aberration at the paraxial focus 117 of the laser machining head 116 proportional to the power of the divergence angle of the laser light 144 and setting the value of the power index β to be smaller than three. Consequently, the laser machining apparatuses 31 and 41 can obtain a higher reduction effect of the spatter 146, and can realize high-quality machining.

In Formula (3), by using the aspherical coefficient Aⱼ of a higher order, the lateral aberration ΔY can be easily made proportional to the β-power of the divergence angle θ as compared with a case where only A₄ is used as the aspherical coefficient. Using the aspherical coefficient Aⱼ, the range of values of the power index β that can make it easier to make the lateral aberration ΔY proportional to the B-power of the divergence angle θ is, for example, 2.5≤β≤3.5. Therefore, for example, when the value of the power index β is 2.5 or more and less than 3, a higher reduction effect of the spatter 146 can be obtained, and higher-quality machining can be realized.

In FIG. 15, the case where the value of the power index β is three and the case where the value of the power index β is smaller than three have been described, but the value of the power index β may be larger than three in order to obtain the optimum intensity of the peripheral beam 161 according to the workpiece 143. Therefore, for example, when the value of the power index β is greater than 3 and equal to or less than 3.5, the optimal intensity of the peripheral beam 161 according to the workpiece 143 can be obtained. In a case where the value of the power index β is three, lateral aberration similar to spherical aberration can be generated at the paraxial focus 117 of the laser machining head 116.

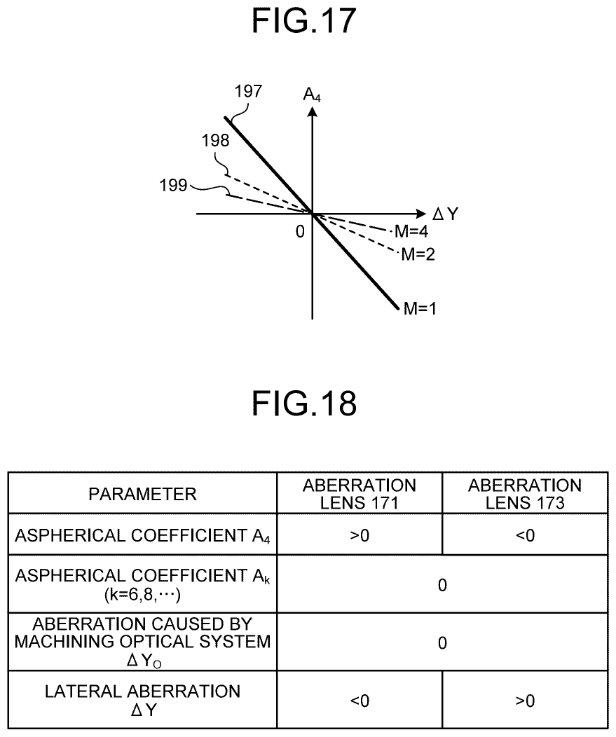

FIG. 17 is a diagram illustrating an example of the relationship between the aspherical coefficient and the lateral aberration in the first embodiment. FIG. 17 is a graph illustrating the relationship between A₄, which is the fourth-order aspherical coefficient in Formula (3), and the lateral aberration ΔY at the paraxial focus 117 of the laser machining head 116 when the divergence angle θ is constant θ₂. In FIG. 17, a solid line 197 represents the relationship between the aspherical coefficient A₄ and the lateral aberration ΔY in a case where the optical magnification M=f_{f}/f_{c} of the machining optical system 114 is one time. A broken line 198 represents the relationship between the aspherical coefficient A₄ and the lateral aberration ΔY in a case where the optical magnification M is two times. A line 199, which is an alternate long and short dash line, represents the relationship between the aspherical coefficient A₄ and the lateral aberration ΔY in a case where the optical magnification M is four times.

FIG. 18 is a diagram illustrating an example of parameters for the aberration lenses 171 and 173 having the characteristics that are the relationships illustrated in FIG. 17. The parameters are the aspherical coefficients A₄ and Aₖ of the aberration lenses 171 and 173, ΔYₒ which is the aberration caused by the machining optical system 114, and the lateral aberration ΔY. Here, k is an even number of six or more. The lateral aberration ΔY is a lateral aberration generated at the paraxial focus 117 of the laser machining head 116 after the laser light 144 passes through the aberration lenses 171 and 173 and the machining optical system 114.

In FIG. 18, for the sake of simplified explanation, it is assumed that the aspherical coefficient Aₖ is zero and ΔYₒ is zero. ΔYₒ being zero means that no aberration occurs due to the machining optical system 114 or that the aberration caused by the machining optical system 114 is negligibly small. The value of the aspherical coefficient A₄ in the aberration lens 171 is a positive value. The lateral aberration ΔY in the case of using the aberration lens 171 is a negative lateral aberration. The value of the aspherical coefficient A₄ in the aberration lens 173 is a negative value. The lateral aberration ΔY in the case of using the aberration lens 173 is a positive lateral aberration.

As illustrated in FIG. 17, a proportional relationship is established between the aspherical coefficient A₄ and the lateral aberration ΔY. In addition, by changing the optical magnification M, the slope of the graph representing the relationship between the aspherical coefficient A₄ and the lateral aberration ΔY changes. A proportional relationship is established between the slope of the graph and the reciprocal of the optical magnification M. The relationship between the aspherical coefficient A₄ and the lateral aberration ΔY is expressed by Formula (5) below.

$$\begin{matrix}Formula 5 & \\ {A}_{4} ∝ \frac{Δ Y}{M} & ( 5 )\end{matrix}$$

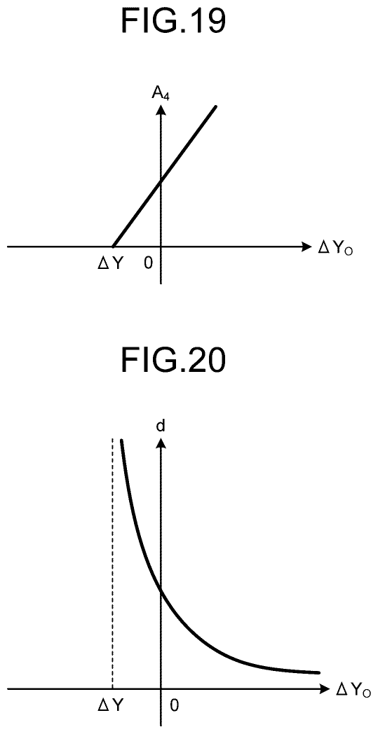

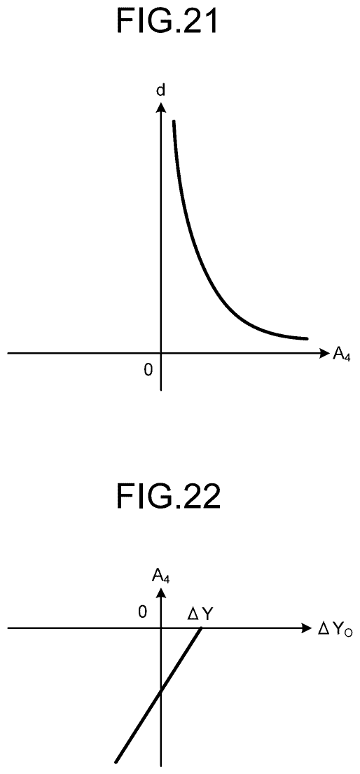

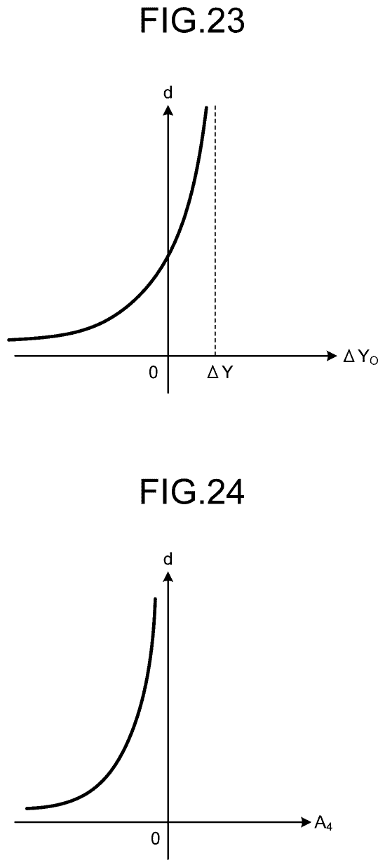

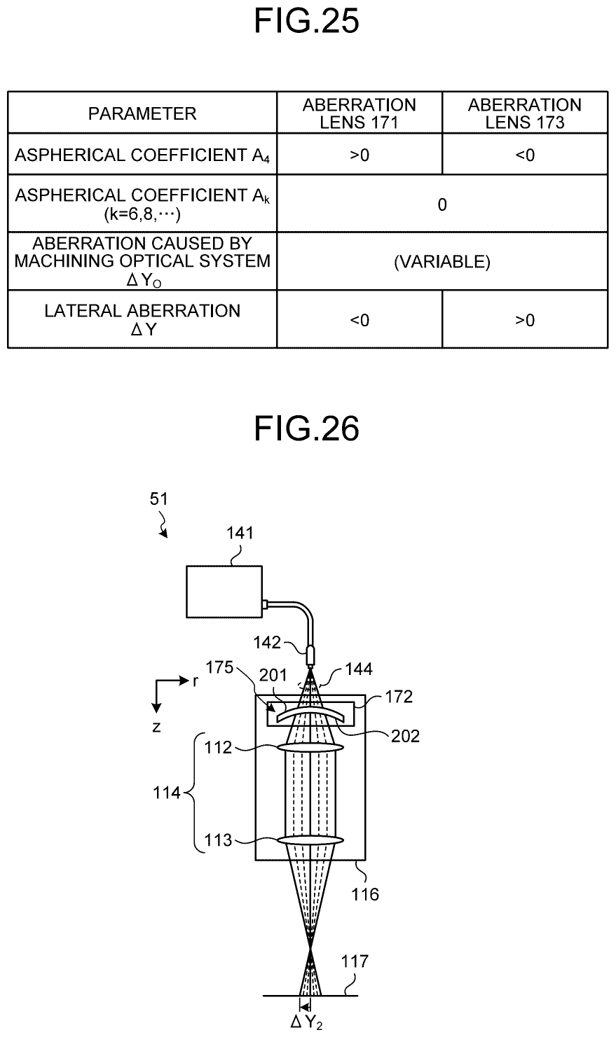

Next, a case where aberration can occur due to the machining optical system 114, that is, a case where ΔYₒ is a value other than zero will be described. FIG. 19 is a diagram illustrating an example of the relationship between the aberration ΔYₒ caused by the machining optical system 114 and the aspherical coefficient A₄ in a case where the convex aberration lens 171 is used in the first embodiment. FIG. 20 is a diagram illustrating an example of the relationship between the aberration ΔY, caused by the machining optical system 114 and the movement amount d of the aberration lens 171 in a case where the convex aberration lens 171 is used in the first embodiment. FIG. 21 is a diagram illustrating an example of the relationship between the aspherical coefficient A₄ and the movement amount d of the aberration lens 171 in a case where the convex aberration lens 171 is used in the first embodiment. FIG. 22 is a diagram illustrating an example of the relationship between the aberration ΔYₒ caused by the machining optical system 114 and the aspherical coefficient A₄ in a case where the concave aberration lens 173 is used in the first embodiment. FIG. 23 is a diagram illustrating an example of the relationship between the aberration ΔYₒ caused by the machining optical system 114 and the movement amount d of the aberration lens 173 in a case where the concave aberration lens 173 is used in the first embodiment. FIG. 24 is a diagram illustrating an example of the relationship between the aspherical coefficient A₄ and the movement amount d of the aberration lens 173 in a case where the concave aberration lens 173 is used in the first embodiment. FIG. 25 is a diagram illustrating an example of parameters for the aberration lens 171 having the characteristics that are the relationships illustrated in FIGS. 19 to 21 and the aberration lens 173 having the characteristics that are the relationships illustrated in FIGS. 22 to 24.

In the example illustrated in FIG. 25, similarly to the case of FIG. 18, the aspherical coefficient Aₖ is zero. In FIG. 25, ΔYₒ, which is aberration caused by the machining optical system 114, is a variable. The lateral aberration ΔY in the case of using the aberration lens 171 is a constant value that is a negative value. The lateral aberration ΔY in the case of using the aberration lens 173 is a constant value that is a positive value.

FIGS. 19 and 22 are graphs illustrating the relationship between the aberration ΔYₒ caused by the machining optical system 114 and the aspherical coefficient A₄. As illustrated in FIG. 19, when the aspherical coefficient A₄ is zero, the aberration due to the aberration lens 171 does not occur, and ΔYₒ=ΔY is obtained. As illustrated in FIG. 22, when the aspherical coefficient A₄ is zero, the aberration due to the aberration lens 173 does not occur, and ΔYₒ=ΔY is obtained. That is, when the aspherical coefficient A₄ is zero, the aberration ΔYₒ caused by the machining optical system 114 is equal to the lateral aberration ΔY at the paraxial focus 117 of the laser machining head 116.

As illustrated in FIG. 19, the aspherical coefficient A₄ in the aberration lens 171 increases as the aberration ΔYₒ caused by the machining optical system 114 increases. As illustrated in FIG. 22, the aspherical coefficient A₄ in the aberration lens 173 increases as the aberration ΔYₒ caused by the machining optical system 114 increases.

FIGS. 20 and 23 are graphs illustrating the relationship between the aberration ΔYₒ caused by the machining optical system 114 and the movement amount d of the aberration lenses 171 and 173. Here, suppose that when the divergence angle θ is θ₁ and the position of the aberration lenses 171 and 173 on the optical axis is P₁, and when the divergence angle θ is θ₂ and the position of the aberration lenses 171 and 173 on the optical axis is P₂, the lateral aberration ΔY at the paraxial focus 117 of the laser machining head 116 is equal. In this case, the movement amount d is the distance between the position P₁ and the position P₂. That is, d=|P₁−P₂| holds.

As illustrated in FIG. 20, the movement amount d increases as the value of the aberration ΔYₒ caused by the machining optical system 114 approaches the value of the lateral aberration ΔY. As illustrated in FIG. 23, the movement amount d increases as the value of the aberration ΔYₒ caused by the machining optical system 114 approaches the value of the lateral aberration ΔY. In addition, as illustrated in FIG. 20, in a case where the lateral aberration ΔY is a negative lateral aberration, the movement amount d can be reduced as the aberration ΔYₒ caused by the machining optical system 114 is increased. As illustrated in FIG. 23, in a case where the lateral aberration ΔY is a positive lateral aberration, the movement amount d can be reduced as the aberration ΔYₒ caused by the machining optical system 114 is reduced. As the movement amount d decreases, the movable range of the movable mechanism 172 can be reduced, and the movable mechanism 172 can be downsized.

The general machining optical system 114 makes the aberration ΔYₒ zero or negligibly small. On the other hand, in the case of the relationships illustrated in FIGS. 20 and 23, the movement amount d can be reduced by reversing the sign of the aberration ΔYₒ caused by the machining optical system 114 with respect to the sign of the lateral aberration ΔY at the paraxial focus 117 of the laser machining head 116. That is, when the lateral aberration ΔY is a positive value, the aberration ΔYₒ is set to a negative value, and when the lateral aberration ΔY is a negative value, the aberration ΔYₒ is set to a positive value.

FIGS. 21 and 24 are graphs illustrating the relationships between the aspherical coefficient A₄ and the movement amount d of the aberration lenses 171 and 173. The relationship illustrated in FIG. 21 is derived from the relationship illustrated in FIG. 19 and the relationship illustrated in FIG. 20. The relationship illustrated in FIG. 24 is derived from the relationship illustrated in FIG. 22 and the relationship illustrated in FIG. 23.

As illustrated in FIG. 21, the movement amount d decreases as the aspherical coefficient A₄ which is a positive value increases. As illustrated in FIG. 24, the movement amount d decreases as the aspherical coefficient A₄ which is a negative value decreases. That is, according to FIGS. 21 and 24, the movement amount d decreases as the absolute value of the aspherical coefficient A₄ increases. Therefore, by increasing the absolute value of the aspherical coefficient A₄, the movable range of the movable mechanism 172 can be reduced, and the movable mechanism 172 can be downsized.

In FIGS. 17 to 25, the aspherical coefficient Aₖ is set to zero for the sake of simplified explanation, but the aspherical coefficient Aₖ may be a value other than zero in the first embodiment. With the aspherical coefficient Aₖ being a value other than zero, the divergence angles θ₁ and θ₂ at which the lateral aberration ΔY at the paraxial focus 117 of the laser machining head 116 is equal can be realized in a wider divergence angle range θᵣ=θ₁−θ₂. By moving the aberration lenses 171 and 173 in which the aspherical coefficient Aₖ is a value other than zero in the direction of the optical axis, the beam shape at the irradiation position of the laser light 144 can be made the same in a wider divergence angle range θᵣ. As a result, the laser machining apparatuses 31 and 41 can realize stable machining in a wider divergence angle range θᵣ. The divergence angle range θᵣ may be, for example, the same as the divergence angle range of the laser light 144 emitted from the optical fiber 142. For example, when the divergence angle range of the laser light 144 is 50 mrad to 110 mrad, the divergence angle range Or may be 110 mrad−50 mrad=60 mrad.

In the first embodiment, the aberration lenses 171, 173, and 174 that are single lenses are used as the aberration optical system, but the present disclosure is not limited thereto. The aberration optical system may include a plurality of lenses. Alternatively, the aberration optical system may be an optical system including an optical element other than lenses.

### Second Embodiment

In the second embodiment, three exemplary configurations of a laser machining apparatus will be described. In the second embodiment, components identical to those in the first embodiment are denoted by the same reference signs, and configuration differences from the first embodiment will be mainly described.

FIG. 26 is a diagram illustrating a configuration of a laser machining apparatus 51 according to a first example of the second embodiment. The laser machining apparatus 51 is different from the laser machining apparatus 31 illustrated in FIG. 10 in that an aberration lens 175 is provided instead of the aberration lens 171. Except this, the laser machining apparatus 51 is similar to the laser machining apparatus 31. In the first example of the second embodiment, the aberration optical system is the aberration lens 175 that is a single lens. The aberration lens 175 is a convex lens having a convex surface that is a spherical surface.

The laser machining head 116 includes the movable mechanism 172 that moves the aberration lens 175 in the direction of the optical axis. The laser machining apparatus 51 includes a control device that controls the movable mechanism 172. The operation of the aberration lens 175 by the movable mechanism 172 is similar to that in the case of the aberration lens 171. The aberration lens 175 including a spherical surface can be easily created as compared with a lens including an aspherical surface. In the first example, the machining optical system 114 is an optical system that does not cause aberration. The machining optical system 114 may be an optical system that causes negligibly small aberration. In FIG. 26, illustration of the workpiece 143 and the control device is omitted.

The aberration lens 175 has, for example, a first surface 201 that is a spherical and convex surface and a second surface 202 that is a spherical and convex surface. The first surface 201 and the second surface 202 have different curvatures C from each other. The aberration lens 175 has no refractive power with respect to the light ray on the central axis. The central axis of the aberration lens 175 overlaps the optical axis of the laser light 144 passing through the aberration lens 175. In the laser machining apparatus 51 illustrated in FIG. 26, the first surface 201 is an incident surface on which the laser light 144 is incident, and the second surface 202 is an emission surface from which the laser light 144 is emitted. Note that the phrase “having no refractive power with respect to the light ray on the central axis” includes a state in which the refractive power with respect to the light ray on the central axis is negligibly small.

Since the aberration lens 175 has no refractive power with respect to the light ray on the central axis, even when the aberration lens 175 is moved by the movable mechanism 172, the change in the position of the paraxial focus 117 of the laser machining head 116 is small. Consequently, the laser machining apparatus 51 can stabilize the irradiation position of the laser light 144.

Given that the curvature of the first surface 201 is C₁, the curvature of the second surface 202 is C₂, the center thickness of the aberration lens 175 is t, and the refractive index of the aberration lens 175 is n, the relationship between the curvatures C₁ and C₂ when there is no refractive power with respect to the light ray on the central axis is expressed by Formula (6) below. Here, C₁≠0 and C₂≠0 hold.

$$\begin{matrix}Formula 6 & \\ \frac{1}{{C}_{1}} = ( n - 1 ) \frac{t}{n} + \frac{1}{{C}_{2}} & ( 6 )\end{matrix}$$

The combination of the curvatures C₁ and C₂ can be selected so as to satisfy Formula (6) and obtain a desired lateral aberration at the paraxial focus 117 of the laser machining head 116.

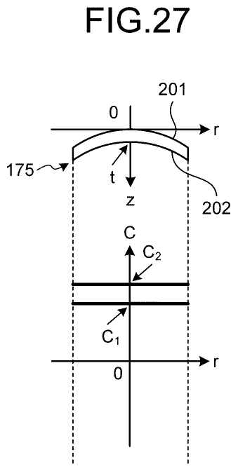

FIG. 27 is a diagram for explaining a configuration of the aberration optical system in the second embodiment. FIG. 27 illustrates an example of the shape of the aberration lens 175 as the aberration optical system and the curvatures C₁ and C₂. Each of the curvatures C₁ and C₂ is constant regardless of r. In addition, as can be seen from Formula (6), C₁<C₂ holds. Although FIGS. 26 and 27 illustrate an example in which each of the curvature C₁ and the curvature C₂ is a positive value, each of the curvature C₁ and the curvature C₂ may be a negative value.

By moving the aberration lens 175 in the direction of the optical axis by the movable mechanism 172, the laser machining apparatus 51 can cause the same lateral aberration ΔY₂ at the paraxial focus 117 of the laser machining head 116 for the laser light 144 having different divergence angles θ. Consequently, the laser machining apparatus 51 can reduce the change in the beam shape at the irradiation position, and can realize stable machining.

The aberration lens 175 may have refractive power on the central axis as long as the position of the paraxial focus 117 of the laser machining head 116 does not change significantly. Alternatively, the aberration lens 175 may have refractive power in the center region 185 similarly to the aberration lens 174 illustrated in FIG. 14(D). In the case of having refractive power in the center region 185, the absolute value of the refractive power in the center region 185 of the aberration lens 175 is, for example, 1/10 or less of the refractive power of the collimator lens 112. The absolute value of the refractive power in the center region 185 of the aberration lens 175 may be 1/100 or less of the refractive power of the collimator lens 112.

Given that the focal length f_{c} of the collimator lens 112 is 200 mm, the refractive power of the collimator lens 112 corresponds to 5D. Therefore, the absolute value of the refractive power in the center region 185 of the aberration lens 175 is, for example, 0.5D or less corresponding to 1/10 or less of 5D. The absolute value of the refractive power in the center region 185 of the aberration lens 175 may be 0.05D or less corresponding to 1/100 or less of the refractive power of the collimator lens 112.

The curvature C₁ of the first surface 201 and the curvature C₂ of the second surface 202 may be set such that a combined focal length f_{c} of the combination of the aberration lens 175 and the collimator lens 112 is equal to the focal length f_{c} of the collimator lens 112. Hereinafter, a combination of the aberration optical system and the collimating optical system is referred to as a combination collimating optical system. Here, the combination collimating optical system is a combination collimator lens that is a combination of the aberration lens 175 and the collimator lens 112.

The combined focal length fₑ is obtained by obtaining a ray tracing matrix F_{c} from the emission end of the optical fiber 142 to the passage through the combination collimator lens, and multiplying the reciprocal of the 2-by-1 column component of the ray tracing matrix Fe by −1. The ray tracing matrix Fe is expressed by Formula (7) below.

$$\begin{matrix}Formula 7 & \\ {F}_{e} = ( \begin{matrix}1 & 0 \\ - 1 / {f}_{c} & 1\end{matrix} ) ( \begin{matrix}1 & {d}_{1} \\ 0 & 1\end{matrix} ) ( \begin{matrix}1 & 0 \\ ( n - 1 ) {C}_{2} & n\end{matrix} ) ( \begin{matrix}1 & t \\ 0 & 1\end{matrix} ) ( \begin{matrix}1 & 0 \\ ( 1 - n ) {C}_{1} / n & 1 / n\end{matrix} ) ( \begin{matrix}1 & {d}_{0} \\ 0 & 1\end{matrix} ) & ( 7 )\end{matrix}$$

In Formula (7), the collimator lens 112 is assumed to be a thin lens having the focal length f_{c}. Here, d₀ is the distance between the emission end of the optical fiber 142 and the first surface 201 of the aberration lens 175. In addition, d₁ is the distance between the second surface 202 of the aberration lens 175 and the collimator lens 112.

When the combined focal length fₑ of the combination collimator lens is equal to the focal length f_{c} of the collimator lens 112, the curvatures C₁ and C₂ satisfy Formula (8) below. Here, C₁≠0 and C₂≠0 hold.

$$\begin{matrix}Formula 8 & \\ \frac{1}{{C}_{1}} = ( n - 1 ) \frac{t}{n} + \frac{1}{{C}_{2}} + \frac{1}{{C}_{2} ( {d}_{1} - {f}_{c} )} \frac{t}{n} & ( 8 )\end{matrix}$$

In this case, each of the distance d₁ and the focal length f_{c} may be a desired value. By including the combination collimating optical system that satisfies fₑ=f_{c}, the laser machining apparatus 51 can obtain a desired aberration at the paraxial focus 117 of the laser machining head 116, and can realize stable machining. In the above description, the collimator lens 112 is assumed to be a thin lens, but the collimator lens 112 may be assumed to be, for example, a plano-convex lens or a lens with minimized spherical aberration.

FIG. 26 illustrates the aberration lens 175 in which both the first surface 201 and the second surface 202 are spherical surfaces as an example. However, the aberration lens 175 is not limited to the aberration lens in which both the first surface 201 and the second surface 202 are spherical surfaces. In the aberration lens 175, the first surface 201 or the second surface 202 may be replaced with an aspherical surface represented by Formula (1). For example, when the aberration lens 175 includes the first surface 201 replaced with an aspherical surface and the second surface 202 that is a spherical surface, the curvature of the first surface 201, the curvature C₁, is replaced with the curvature C₀ expressed by Formula (1). Also in this case, the laser machining apparatus 51 can reduce the change in the position of the paraxial focus 117 of the laser machining head 116 when the aberration lens 175 is moved by the movable mechanism 172, and can stabilize the irradiation position of the laser light 144.

In addition, by replacing the first surface 201 or the second surface 202 with an aspherical surface, a desired aberration can be easily obtained at the paraxial focus 117 of the laser machining head 116. For example, in a case where both the first surface 201 and the second surface 202 are spherical surfaces, an attempt to increase the absolute value of the lateral aberration at the paraxial focus 117 of the laser machining head 116 causes the absolute values of the curvatures C₁ and C₂ to increase. On the other hand, by replacing one of the first surface 201 and the second surface 202 with an aspherical surface, it is possible to prevent the absolute values of the curvatures C₁ and C₂ from increasing, and to easily obtain a desired aberration.

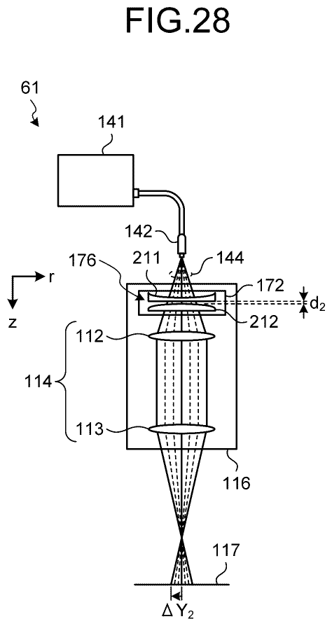

FIG. 28 is a diagram illustrating a configuration of a laser machining apparatus 61 according to a second example of the second embodiment. The laser machining apparatus 61 is different from the laser machining apparatus 51 illustrated in FIG. 26 in that an aberration lens 176 is provided instead of the aberration lens 175. Except this, the laser machining apparatus 61 is similar to the laser machining apparatus 51. The aberration lens 176 is an aberration optical system including a plurality of spherical lenses.

The aberration lens 176 illustrated in FIG. 28 includes a first lens 211 and a second lens 212. The first lens 211 is a plano-concave spherical lens having an incident surface that is a spherical and concave surface and an emission surface that is a flat surface. The second lens 212 is a plano-convex spherical lens having an incident surface that is a spherical and convex surface and an emission surface that is a flat surface. In the second example, the highly versatile plano-concave spherical lens and plano-convex spherical lens are used for the aberration lens 176, so that the optical system of the laser machining head 116 can be easily constructed.

The laser machining head 116 includes the movable mechanism 172 that moves the aberration lens 176 in the direction of the optical axis. The laser machining apparatus 61 includes a control device that controls the movable mechanism 172. The operation of the aberration lens 176 by the movable mechanism 172 is similar to that in the case of the aberration lens 171. In the second example, the machining optical system 114 is an optical system that does not cause aberration. The machining optical system 114 may be an optical system that causes negligibly small aberration. In FIG. 28, illustration of the workpiece 143 and the control device is omitted.

Given that the curvature of the incident surface of the first lens 211 is C₃ and the curvature of the incident surface of the second lens 212 is C₄, the relationship between the curvatures C₃ and C₄ when there is no refractive power with respect to the light ray on the central axis is expressed by Formula (9) below. The phrase “having no refractive power with respect to the light ray on the central axis” includes a state in which the refractive power with respect to the light ray on the central axis is negligibly small. Here, C₃≠0 and C₄≠0 hold.

$$\begin{matrix}Formula 9 & \\ \frac{1}{{C}_{3}} = ( n - 1 ) \frac{{t}_{3}}{n} - \frac{1}{{C}_{4}} + {d}_{2} ( n - 1 ) & ( 9 )\end{matrix}$$

Here, t₃ is the center thickness of the first lens 211, and d₂ is the distance between the emission surface of the first lens 211 and the second lens 212. The combination of the curvatures C₃ and C₄ can be selected so as to satisfy Formula (9) and obtain a desired lateral aberration at the paraxial focus 117 of the laser machining head 116.

Since the aberration lens 176 has no refractive power with respect to the light ray on the central axis, even when the aberration lens 176 is moved by the movable mechanism 172, the change in the position of the paraxial focus 117 of the laser machining head 116 is small. Consequently, the laser machining apparatus 61 can stabilize the irradiation position of the laser light 144. By moving the aberration lens 176 in the direction of the optical axis while keeping the distance d₂ constant, the laser machining apparatus 61 can move the aberration lens 176 while maintaining a state in which there is no refractive power with respect to the light ray on the central axis. The laser machining apparatus 61 can reduce the change in the beam shape at the irradiation position, and can realize stable machining.

The curvature C₃ of the incident surface of the first lens 211 and the curvature C₄ of the incident surface of the second lens 212 may be set such that a combined focal length fₑ₂ of the combination of the aberration lens 176 and the collimator lens 112 is equal to the focal length f_{c} of the collimator lens 112. In the second example, the combination collimating optical system is a combination collimator lens that is a combination of the aberration lens 176 and the collimator lens 112.

The combined focal length fₑ₂ is obtained by obtaining a ray tracing matrix Fₑ₂ from the emission end of the optical fiber 142 to the passage through the combination collimator lens, and multiplying the reciprocal of the 2-by-1 column component of the ray tracing matrix Fₑ₂ by −1. The ray tracing matrix Fez can be obtained similarly to the ray tracing matrix Fe shown in Formula (7). Here, description of a method for obtaining the ray tracing matrix Fₑ₂ is omitted.

Even in the case fₑ=f_{c}, by moving the aberration lens 176 in the direction of the optical axis while keeping the distance de constant, the laser machining apparatus 61 can move the aberration lens 176 while maintaining a state in which there is no refractive power with respect to the light ray on the central axis. By including the combination collimating optical system that satisfies fₑ=f_{c}, the laser machining apparatus 61 can obtain a desired aberration at the paraxial focus 117 of the laser machining head 116, and can realize stable machining.

FIG. 28 illustrates the aberration lens 176 including the first lens 211 having the incident surface that is a concave surface and the second lens 212 having the incident surface that is a convex surface as an example, but the configuration of the aberration lens 176 in the second example is not limited thereto. The emission surface of the first lens 211 may be a convex surface, and the emission surface of the second lens 212 may be a concave surface.

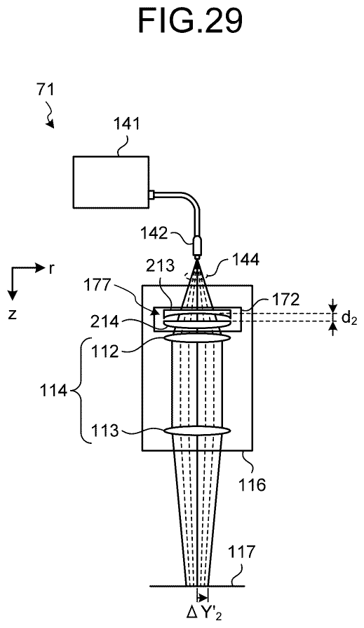

FIG. 29 is a diagram illustrating a configuration of a laser machining apparatus 71 according to a third example of the second embodiment. The laser machining apparatus 71 is different from the laser machining apparatus 51 illustrated in FIG. 26 in that an aberration lens 177 is provided instead of the aberration lens 175. Except this, the laser machining apparatus 71 is similar to the laser machining apparatus 51. The aberration lens 177 is an aberration optical system including a plurality of spherical lenses.

The aberration lens 177 illustrated in FIG. 29 includes a first lens 213 and a second lens 214. The first lens 213 is a plano-concave spherical lens having an incident surface that is a flat surface and an emission surface that is a spherical and concave surface. The second lens 214 is a plano-convex spherical lens having an incident surface that is a flat surface and an emission surface that is a spherical and convex surface. In the third example, the highly versatile plano-concave spherical lens and plano-convex spherical lens are used for the aberration lens 177, so that the optical system of the laser machining head 116 can be easily constructed.

The laser machining head 116 includes the movable mechanism 172 that moves the aberration lens 177 in the direction of the optical axis. The laser machining apparatus 71 includes a control device that controls the movable mechanism 172. The operation of the aberration lens 177 by the movable mechanism 172 is similar to that in the case of the aberration lens 171. In the third example, the machining optical system 114 is an optical system that does not cause aberration. The machining optical system 114 may be an optical system that causes negligibly small aberration. In FIG. 29, illustration of the workpiece 143 and the control device is omitted.

The laser machining apparatus 71 can stabilize the irradiation position of the laser light 144 similarly to the case of the laser machining apparatus 61 illustrated in FIG. 28. The laser machining apparatus 71 can reduce the change in the beam shape at the irradiation position, and can realize stable machining.

FIG. 29 illustrates the aberration lens 177 including the first lens 213 having the emission surface that is a concave surface and the second lens 214 having the emission surface that is a convex surface as an example, but the configuration of the aberration lens 177 in the third example is not limited thereto. The incident surface of the first lens 213 may be a convex surface, and the incident surface of the second lens 214 may be a concave surface.

In FIGS. 28 and 29, an example is illustrated in which each of the aberration lenses 176 and 177 includes two spherical lenses, but each of the aberration lenses 176 and 177 may include three or more spherical lenses. The lens constituting the aberration lenses 176 and 177 is not limited to the plano-concave spherical lens or the plano-convex spherical lens. The lens constituting the aberration lenses 176 and 177 may be a biconvex spherical lens, a biconcave spherical lens, a convex meniscus lens, or a concave meniscus lens.

The curvature of the first lenses 211 and 213 and the curvature of the second lenses 212 and 214 may be obtained based on a ray tracing matrix Fₑ₃ from the incident surface of the first lenses 211 and 213 to the emission surface of the second lenses 212 and 214. In this case, the ray tracing matrix Fₑ₃ is obtained, and the curvature of the first lenses 211 and 213 and the curvature of the second lenses 212 and 214 are determined such that the 2-by-1 column component of the ray tracing matrix Fₑ₃ is zero and the 2-by-2 column component of the ray tracing matrix Fₑ₃ is one.

With the 2-by-1 column component of the ray tracing matrix Fₑ₃ being zero and the 2-by-2 column component of the ray tracing matrix Fₑ₃ being one, even when the aberration lenses 176 and 177 are moved in the direction of the optical axis by the movable mechanism 172, the position of the paraxial focus 117 of the laser machining head 116 does not change, and stable machining can be realized. For example, by using a convex meniscus lens or a concave meniscus lens as the first lenses 211 and 213 or the second lenses 212 and 214, the 2-by-1 column component of the ray tracing matrix Fₑ₃ can be set to zero, and the 2-by-2 column component of the ray tracing matrix Fₑ₃ can be set to one.

### Third Embodiment

In the third embodiment, two exemplary configurations of a laser machining apparatus will be described. In the third embodiment, components identical to those in the first or second embodiment are denoted by the same reference signs, and configuration differences from the first or second embodiment will be mainly described.

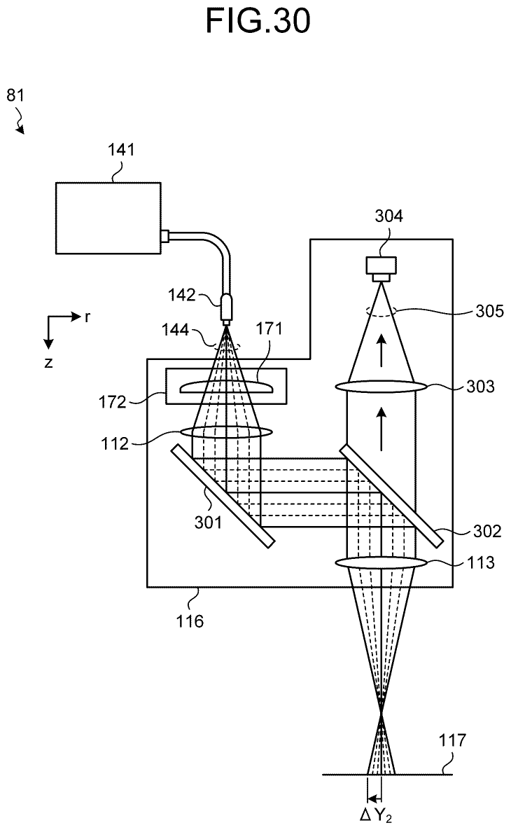

FIG. 30 is a diagram illustrating a configuration of a laser machining apparatus 81 according to a first example of the third embodiment. The laser machining head 116 of the laser machining apparatus 81 includes a first bend mirror 301, a second bend mirror 302, a monitoring lens 303, and a light detection unit 304 in addition to the components similar to those of the laser machining head 116 of the laser machining apparatus 31 illustrated in FIG. 10. The first bend mirror 301, the second bend mirror 302, the monitoring lens 303, and the light detection unit 304 are provided in the laser machining head 116, so that the state of the workpiece 143 and the state of the molten metal 151 can be observed. In FIG. 30, illustration of the workpiece 143 and the control device that controls the movable mechanism 172 is omitted.

The first bend mirror 301 and the second bend mirror 302 are disposed on the optical path between the collimator lens 112 and the condenser lens 113. The first bend mirror 301 reflects the laser light 144 having passed through the collimator lens 112 toward the second bend mirror 302. The second bend mirror 302 reflects the laser light 144 incident from the first bend mirror 301 toward the condenser lens 113. The laser light 144 reflected by the second bend mirror 302 is incident on the condenser lens 113.

The reflecting surface of the second bend mirror 302 is coated, for example, to reflect the laser light 144 and transmit light 305 that has entered the laser machining head 116 from the workpiece 143. The second bend mirror 302 is, for example, a dichroic mirror. The light 305 that has entered the laser machining head 116 from the workpiece 143 and passed through the condenser lens 113 enters the second bend mirror 302. The light 305 that has passed through the second bend mirror 302 is collected at the light detection unit 304 by the monitoring lens 303.

The light detection unit 304 is, for example, an imaging device. The imaging device is, for example, a camera including a charge coupled device (CCD) image sensor or a complementary metal oxide semiconductor (CMOS) image sensor. By imaging the workpiece 143 with the imaging device, the state of the workpiece 143 and the state of the molten metal 151 can be observed. The light detection unit 304 may be a light detector such as a photodiode.

The condenser lens 113, for example, does not cause aberration or causes negligibly small aberration. In a case where the light detection unit 304 is an imaging device, the light 305 can be collected on the imaging device without aberration by eliminating the aberration of the condenser lens 113. Consequently, an image without blurring or distortion can be obtained by the imaging device. In this case, the lateral aberration ΔY, generated at the paraxial focus 117 of the laser machining head 116 is caused by the collimator lens 112 or the aberration lens 171, or by both the collimator lens 112 and the aberration lens 171.

Although FIG. 30 illustrates an example in which the aberration lens 171 is provided in the laser machining head 116, any of the aberration lenses 173, 174, 175, 176, and 177 described above may be provided in the laser machining head 116 instead of the aberration lens 171.

The laser machining apparatus 81 may include an illumination light source that illuminates the workpiece 143. As the illumination light source, a light source such as a light emitting diode (LED) or a laser diode (LD) can be used. By illuminating the workpiece 143 with the illumination light source, the state of the workpiece 143 or the state of the molten metal 151 can be more easily observed.

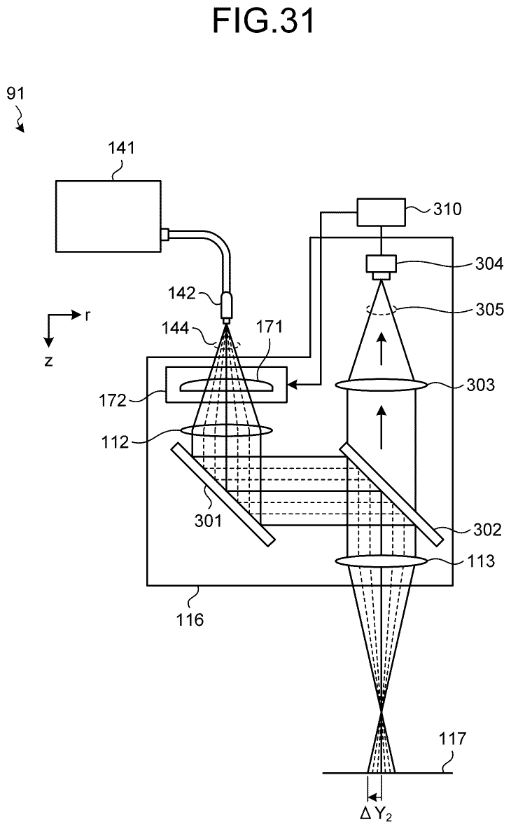

FIG. 31 is a diagram illustrating a configuration of a laser machining apparatus 91 according to a second example of the third embodiment. A control device 310 of the laser machining apparatus 91 controls the movable mechanism 172. In a case where the light detection unit 304 is an imaging device, the control device 310 analyzes an image output from the imaging device and controls the movable mechanism 172 based on the analysis result. The control device 310 moves the aberration lens 171 to an optimum position on the optical axis by controlling the movable mechanism 172. In a case where the light detection unit 304 is a light detector, the control device 310 controls the movable mechanism 172 based on an optical signal detected by the light detector. As a control method that is based on the optical signal, for example, feedback control may be used. In addition, the control device 310 may control the movable mechanism 172 using a control method combined with feedforward control or the like. The laser machining apparatus 91 can maintain stable machining by continuing the control of moving the aberration lens 171 to an optimum position on the optical axis by the control device 310.

Although FIG. 31 illustrates an example in which the aberration lens 171 is provided in the laser machining head 116, any of the aberration lenses 173, 174, 175, 176, and 177 described above may be provided in the laser machining head 116 instead of the aberration lens 171. Although FIG. 31 illustrates an example in which the light detection unit 304 is disposed coaxially with the laser light 144, the light detection unit 304 may be disposed non-coaxially with the laser light 144. In a case where the light detection unit 304 is disposed non-coaxially with the laser light 144, for example, a plurality of light detectors serving as the light detection unit 304 may be disposed non-coaxially. In this case, the laser machining apparatus 91 controls the movable mechanism 172 based on the optical signals from the plurality of light detectors.

Next, hardware for implementing the control device 310 according to the third embodiment will be described. The control device 310 is implemented by processing circuitry. The processing circuitry may be a circuit in which a processor executes software or a dedicated circuit.

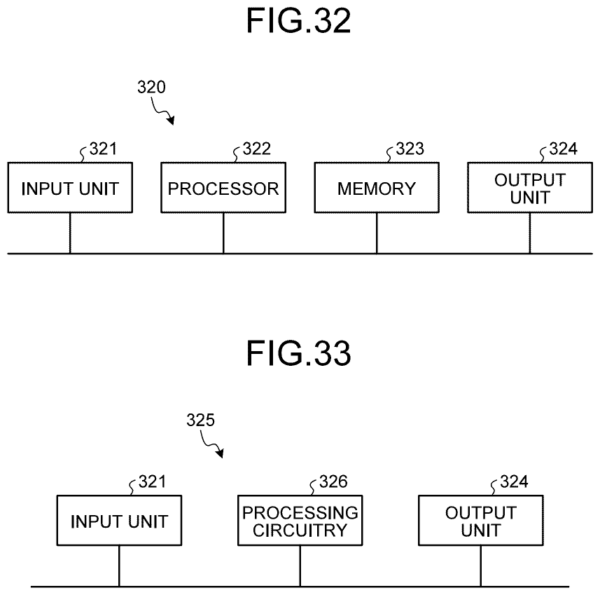

In a case where the processing circuitry is implemented by software, the processing circuitry is, for example, the control circuit illustrated in FIG. 32. FIG. 32 is a diagram illustrating an exemplary configuration of a control circuit 320 according to the third embodiment. The control circuit 320 includes an input unit 321, a processor 322, a memory 323, and an output unit 324. The input unit 321 is an interface circuit that receives data input from the outside of the control circuit 320 and provides data to the processor 322. The output unit 324 is an interface circuit that transmits data from the processor 322 or the memory 323 to the outside of the control circuit 320.

In a case where the processing circuitry is the control circuit 320 illustrated in FIG. 32, the control device 310 is implemented by software, firmware, or a combination of software and firmware. Software or firmware is described as a program and stored in the memory 323. In the processing circuitry, the processor 322 reads and executes the program stored in the memory 323, thereby implementing each function. That is, the processing circuitry includes the memory 323 for storing the programs that result in the processing of the control device 310. It can also be said that these programs cause a computer to execute the procedures and methods for the control device 310.

The processor 322 is a central processing unit (CPU, also referred to as a central machining device, a machining device, a computation device, a microprocessor, a microcomputer, a processor, or a digital signal processor (DSP)). Examples of the memory 323 include a non-volatile or volatile semiconductor memory, a magnetic disk, a flexible disk, an optical disc, a compact disc, a mini disc, a digital versatile disc (DVD), and the like. Examples of the non-volatile or volatile semiconductor memory include a random access memory (RAM), a read only memory (ROM), a flash memory, an erasable programmable read only memory (EPROM), an electrically erasable programmable read only memory (EEPROM, registered trademark), and the like.

FIG. 32 is an example of hardware for implementing each of the components with the general-purpose processor 322 and memory 323, but each of the components may be implemented by a dedicated hardware circuit. FIG. 33 is a diagram illustrating an exemplary configuration of a dedicated hardware circuit 325 according to the third embodiment.

The dedicated hardware circuit 325 includes the input unit 321, the output unit 324, and processing circuitry 326. The processing circuitry 326 is a single circuit, a composite circuit, a programmed processor, a parallel programmed processor, an application specific integrated circuit (ASIC), a field programmable gate array (FPGA), or a circuit that is a combination thereof. The functions of the control device 310 may be implemented by the processing circuitry 326 separately or collectively. Note that the control device 310 may be implemented by combining the control circuit 320 and the hardware circuit 325.

The configurations described in the above-mentioned embodiments indicate examples of the contents of the present disclosure. The configurations of the embodiments can be combined with another well-known technique. The configurations of the embodiments may be combined with each other as appropriate. Some of the configurations of the embodiments can be omitted or changed without departing from the gist of the present disclosure.

### REFERENCE SIGNS LIST

21, 31, 41, 51, 61, 71, 81, 91 laser machining apparatus; 111 point light source; 112 collimator lens; 113 condenser lens; 114 machining optical system; 116 laser machining head; 117 paraxial focus; 118, 119, 145, 165, 167, 195, 196 profile; 120 progress direction; 121, 122 light ray; 141 laser oscillator; 142 optical fiber; 143 workpiece; 144 laser light; 146 spatter; 147 keyhole; 148 front wall; 149 rear wall; 150 molten metal flow; 151 molten metal; 152 bottom; 153 surface; 154 reference surface; 155 opening; 160 main beam; 161 peripheral beam; 162 evaporation reaction force; 163 metal vapor; 166 peripheral beam width; 171, 173, 174, 175, 176, 177 aberration lens; 172 movable mechanism; 180 plano-convex spherical lens; 181, 183, 201 first surface; 182, 184, 202 second surface; 185 center region; 186 peripheral region; 190, 191, 192, 193, 194, 197, 198, 199 line; 211, 213 first lens; 212, 214 second lens; 301 first bend mirror; 302 second bend mirror; 303 monitoring lens; 304 light detection unit; 305 light; 310 control device; 320 control circuit; 321 input unit; 322 processor; 323 memory; 324 output unit; 325 hardware circuit; 326 processing circuitry.

1. A laser machining head comprising:
an aberration optical system disposed at a position within a range in which laser light emitted toward a workpiece spreads in a propagation direction of the laser light, and to cause aberration; and
a collimating optical system through which the laser light propagates, wherein
a center region of the aberration optical system, the center region being a region where a distance from a central axis of the aberration optical system is equal to or less than a boundary value, has no refractive power or has a refractive power with an absolute value equal to or less than 1/10 of a refractive power of the collimating optical system, and
a peripheral region of the aberration optical system, the peripheral region being a region where a distance from the central axis exceeds the boundary value, has a light collecting characteristic in which when a light ray parallel to the central axis is incident on the peripheral region, the light ray at a position farther from the central axis has a shorter distance between the aberration optical system and a focal point of the light ray.

2. The laser machining head according to claim 1, wherein a combined focal length of a combination of the aberration optical system and the collimating optical system is equal to a focal length of the collimating optical system.

3. The laser machining head according to claim 1, wherein
a lateral aberration at a paraxial focus of the laser light having passed through the laser machining head is proportional to a power of a divergence angle of the laser light, and
a power index of the power is a value smaller than three.

4. The laser machining head according to claim 1, wherein the aberration optical system is a single lens, and a portion of the peripheral region of an incident surface of the single lens on which the laser light is incident or a portion of the peripheral region of an emission surface of the single lens from which the laser light is emitted has a shape in which a curvature monotonously increases or monotonously decreases with increasing distance from the central axis.

5. The laser machining head according to claim 1, wherein
a lateral aberration at a paraxial focus of the laser light having passed through the laser machining head is proportional to a power of a divergence angle of the laser light, and
a power index of the power is three.

6. The laser machining head according to claim 1, wherein the aberration optical system includes a plurality of spherical lenses.

7. The laser machining head according to claim 1, comprising a light detection unit to detect light entering the laser machining head from the workpiece.

8. The laser machining head according to claim 1, comprising a movable mechanism to move the aberration optical system in a direction of an optical axis of the laser light passing through the aberration optical system.

9. The laser machining head according to claim 1, comprising
a condensing optical system to collect the laser light, wherein
a sign of lateral aberration at a paraxial focus of the laser light is opposite to a sign of lateral aberration caused by a combination of the collimating optical system and the condensing optical system.

10. A laser machining apparatus comprising:
a laser oscillator to emit laser light; and
the laser machining head according to claim 1.

11. A method for manufacturing a metal product, the method comprising: irradiating a first metal product and a second metal product with laser light having passed through the laser machining head according to claim 1; and welding the first metal product and the second metal product to manufacture a third metal product.
